(19) United States
(12) Patent Application Publication
(10) Pub. No.: US 2012/0149516 A1
(43) Pub. Date: Jun. 14, 2012

(54) HYBRID TRANSMISSION USING PLANETARY GEARSET FOR MULTIPLE SOURCES OF TORQUE FOR AERONAUTICAL VEHICLES

(75) Inventors: Daniel Larrabee, Centennial, CO (US); Thomas Northrop Wormer, Denver, CO (US); Matthew Rhode, Boulder, CO (US); Eric Serani, Boulder, CO (US); Josh Marshman, Broomfield, CO (US); Cody Humbarger, Denver, CO (US); Daniel Gaide, Pueblo, CO (US); Derek Hillery, Boulder, CO (US); Alec Velazco, Boulder, CO (US); Eric Petersen, Centennial, CO (US); Jean Nicolas Koster, Boulder, CO (US)

(73) Assignee: The Regents of the University of Colorado, a body corporate, Denver, CO (US)

(21) Appl. No.: 12/982,130

(22) Filed: Dec. 30, 2010

Related U.S. Application Data
(60) Provisional application No. 61/369,001, filed on Jul. 29, 2010.

(51) Int. Cl. F16H 3/72

(52) U.S. Cl. 475/5; 475/1

(57) ABSTRACT

Provided are alternative hybrid transmission systems for marine, or two wheeled land vehicles, as well as propulsion systems and vehicles comprising such transmission systems, to improve various propulsion systems using a combination of at least two power sources with the option for simultaneous or alternating power input from two or more power sources, while providing desired characteristics or components. Such characteristics or components can include, but are not limited to: power, torque, acceleration, cruising speed or power, fuel efficiency, battery charging, endurance, power sizing, weight, capacity, efficiency, speed, mechanically and/or electrically added system requirements, design, fuel selection, functional design, structural design, lift to drag ratio, weight, and/or other desired characteristic or component.

### PRIORITY

This application claims priority to provisional application No. 61/369,001, filed Jul. 29, 2010, which application is entirely incorporated herein by reference.

### STATEMENT REGARDING FEDERALLY SPONSORED RESEARCH OR DEVELOPMENT

The invention was made with government support under grant number NNX09AF65G awarded by NASA. The government has certain rights in the invention.

### FIELD OF THE INVENTION

The present invention generally relates to a hybrid transmission using a hybrid propulsion system. More specifically, the present invention relates to a clutchless hybrid transmission with a planetary gear system for any type of vehicle.

### BACKGROUND

A vehicle (Latin: vehiculum) is a device that is designed or used to transport people, payloads, or cargo. (e.g. bicycles, cars, motorcycles, trains, ships, boats, and aircraft). Vehicles that do not travel on land often can be called craft, such as watercraft, sailcraft, aircraft, hovercraft, and spacecraft. Land vehicles are classified broadly by what is used to apply steering and drive forces against the ground, e.g., wheeled, tracked, railed, or skied. Propulsion is achieved in different ways, e.g., by wheels, propellers, rotary wings, tracks, water or air jets, skies, turbofans, burning fuel under pressure, and the like, that provide torque from one or more power sources, such as gas, electric, or other motors or power sources. A vehicle can be used for propulsion of personnel or payloads on land, in water, or in air, or a combination thereof.

All vehicles, with the exception of some space vehicles, experience significant frictional drag, typically mainly air, or water drag or rolling resistance. Friction also occurs in many braking systems, although some braking systems are regenerative which permits recovery of some of the energy from the vehicle's motion. The friction generated by the vehicle acting over the distance it travels can determine the energy needed to be expended. For a vehicle that is travelling at constant speed, from the definition of mechanical energy to move a given distance the energy needed is simply: E=Fxs, where E is the energy, F is the friction force and s is the distance. This determines the minimum amount of energy the power source must provide and can determine the vehicle's range.

Vehicles, such as airplanes, require more power for takeoff and landing than is required for

cruising at level flight. Conventional design of propeller driven airplanes involves selecting an engine that is powerful enough to meet the highest power requirements, even though most of the typical flight profile is conducted at cruising speeds requiring lower power. However, the efficiency of internal combustion engines (ICE) is usually quite sensitive to operating power and engine speed, with efficiency falling as power output and engine speed deviate from the maximum efficiency region. Thus, during a typical flight, the aircraft ICE is operated at an inefficient power output. While electric motors are able to operate at high levels of efficiency over a broader range of power output, the energy density and cost of currently available electrical storage systems make all-electric power systems for airplanes problematic.

In view of the above, it will be apparent to those skilled in the art that a need exists for an improved propulsion system for aircraft, such as transmissions, gear boxes or systems for transferring torque between multiple power sources, such as, but not limited to, electric motors or ICEs, and drivetrains, such as propellers, wheels or other propulsion systems. This invention addresses this need in the art as well as other needs, which will become apparent to those skilled in the art from this disclosure, alone, and/or in combination with what is known in the relevant art(s).

### SUMMARY OF THE INVENTION

The invention(s) described herein is/are designed to provide a clutchless or active clutchless hybrid transmission system (and/or gearbox) to improve various propulsion systems using a combination of at least two available power sources, while having one or more desired characteristics, e.g., but not limited to, power, torque, acceleration, cruising, fuel efficiency, battery charging, endurance, power sizing, weight, capacity, efficiency, speed, mechanically and/or electrically added system requirements, design, fuel selection, functional design, structural design, lift to drag ratio, weight, and/or other desired characteristic or component.

These and other objects, features, aspects and advantages of the present invention will become apparent to those skilled in the art from the Description of Drawings Description, and Examples, which, taken in conjunction with the annexed drawings, discloses exemplary embodiments one or more non-limiting aspects of the invention, optionally in combination with what is known in the relevant art(s).

### DESCRIPTION OF THE DRAWINGS

Referring now to the attached drawings which form a part of this original disclosure:

FIG. 1 is a schematic diagram of planetary gear system operably connected to a drive shaft 1, a first power source 2, and a second power source 3, where the drive shaft 1 is connected to the ring gear 4 (optionally by a carrier 6), the first power source is operably connected to a a carrier 4 (optionally connected to the planet gear(s) 5), the second power source 3 is connected to the sun gear 7 (optionally connected to a carrier 6).

FIG. 2A-2D are three-dimensional and cut away diagrams of a hybrid active clutchless transmission and components thereof, for use in a hybrid propulsion system.

FIG. 3 is a graph showing that the efficiency loss by the time the power reaches the propeller is roughly 55% with the slope of this line being almost 0.7.

FIG. 4 is an exploded view of system components for a hybrid active clutchless transmission comprising a planetary gearbox planet assembly consisting of: (101) planet gears 3x; operably connected to: (102) planet carrier 1x; operably connected to: (103) slipper gear assembly; operably connected to (104) ice power drive shaft; and (105) ring gear 1x; operably connected to: (106) ring carrier 1x; operably connected to: (107) propeller drive shaft; operably connected to (108) em power drive shaft. the power source input includes an ice input to the (104) ice power drive shaft (on top of FIG. 4a) which drive shaft is extended to include an additional extension on the ice power source to include a connection to the starter system and to add the (104) slipper gear assembly (as a (109) passive spring clutch (as shown in FIG. 4B) to accommodate temporary high torque to temporarily disengage the ICE power input.

FIG. 5 is an exploded view of system components for a hybrid propulsion system for an aeronautical vehicle comprising a hybrid active clutchless transmission comprising a planetary gearbox.

### DESCRIPTION

At least one invention or development described herein is designed to provide various or alternative clutchless hybrid transmission systems, as well as propulsion systems and vehicles comprising such transmission systems, to improve various propulsion systems using a combination of at least two power sources with the option for simultaneous or alternating power input from two or more power sources, while providing desired characteristics or components. Such characteristics or component can include, but are not limited to: power, torque, acceleration, cruising speed or power, fuel efficiency, battery charging, endurance, power sizing, weight, capacity, efficiency, speed, mechanically and/or electrically added system requirements, design, fuel selection, functional design, structural design, lift to drag ratio, weight, and/or other desired characteristic or component.

A type of “clutchless hybrid transmission system” (optionally including at least one gearbox) can include the use of a, one or more, or at least one planetary or epicyclic gearing system or gearbox that allows power coupling between at least two sources of power and the drivetrain or propulsion drive shaft of a propulsion system. One or more of the power sources can be linked to any component of the planetary gearing system, such as but not limited to a sun, one or more planets, a ring, and/or a carrier or arm. The planetary gear system can be one or more of a standard planetary gear system or a multi-ratio planetary gear system. Considerations in selecting a planetary gear system can include, but are not limited to, one or more of efficiency, gear ratio, torque, RPM requirements, simultaneous input, weight, cost, manufacturing complexity or difficulty, power, acceleration, cruising, fuel efficiency, battery charging, endurance, power sizing, weight, capacity, efficiency, speed, mechanically and/or electrically added system requirements, design, fuel selection, functional design, structural design, lift to drag ratio, and the like.

Alternative forms of a “clutchless hybrid transmission system” are provided that include or comprise, but are not limited to, at least one planetary or epicyclic gearing system that provides alternating power coupling between at least two sources of power and at least one propulsion drive shaft. The power input and/or propulsion drive shaft can be operable linked to one or more of a, one or more, or at least one of, a sun gear, a planetary gears, a ring gear, or a carrier or arm connected thereto, of planetary or epicyclic gearing system.

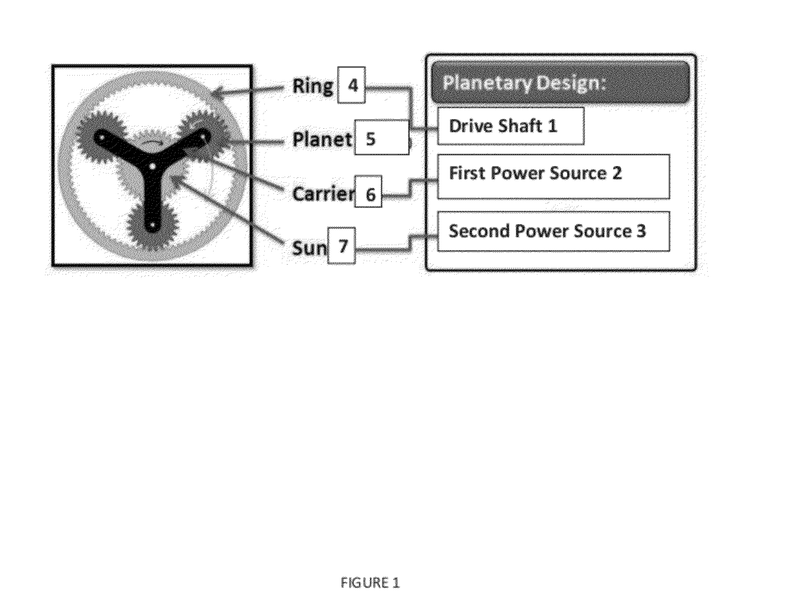

Referring initially to FIG. 1, a hybrid active clutchless transmission is illustrated generally. The hybrid propulsion system 1 includes at least one drive shaft 1, at least one first power source 2 and at least one second power source 3. A hybrid active clutchless transmission advantageously mechanically connects two sources of torque via power drive shafts to the power sources 2, 3. By using two properly selected power sources 2,3, greater total efficiency may be achieved. If the high energy density of conventional fuels or bio fuels is desired, a first power source 2 may be an internal combustion engine or similar type of power source. An internal combustion engine may be sized to operate at maximum efficiency providing power sufficient to operate at various operating speeds. At least one second power source 3 preferably provides efficient power over a variable range, optionally complementary or alternative to first power source 2. When combined with the first power source 2, the second power source 3 meets power needs for alternative or simultaneous operating conditions, or conditions where the second power source 3 can complement or add to the power supplied by the first power source 2. The second power source 3 can optionally be either an internal combustion engine or an electrical motor. Electric motors are generally an efficient power source and may be powered by any electrical energy storage system, such as, for example, batteries, photovoltaic cells, fuel cells, flywheels, or the like, or combinations thereof.

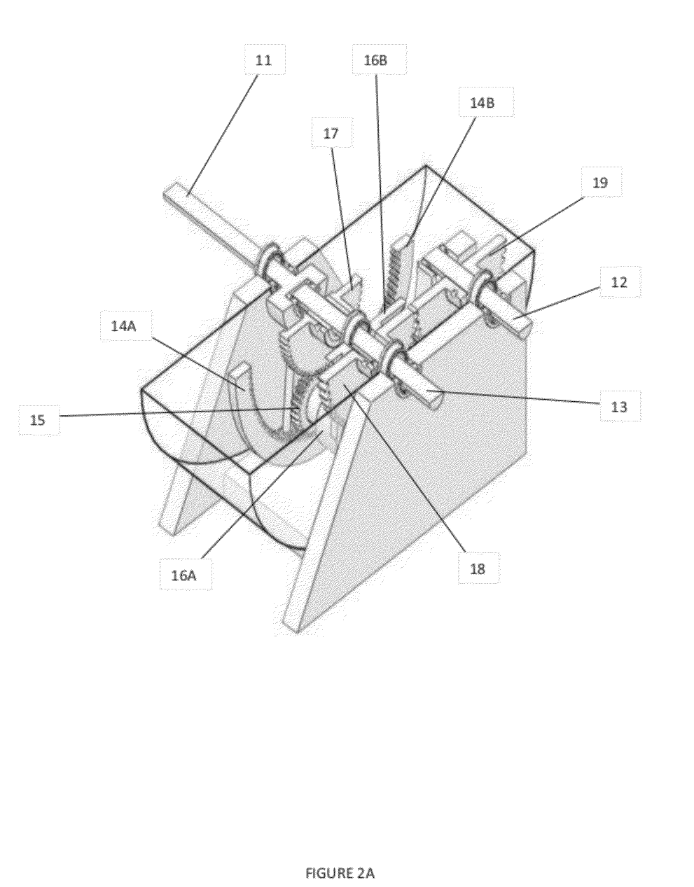

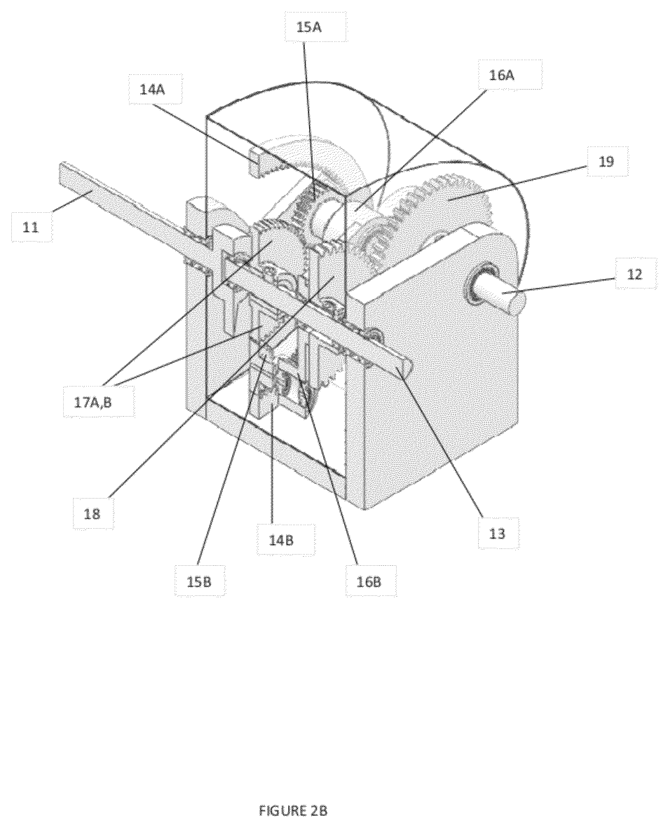

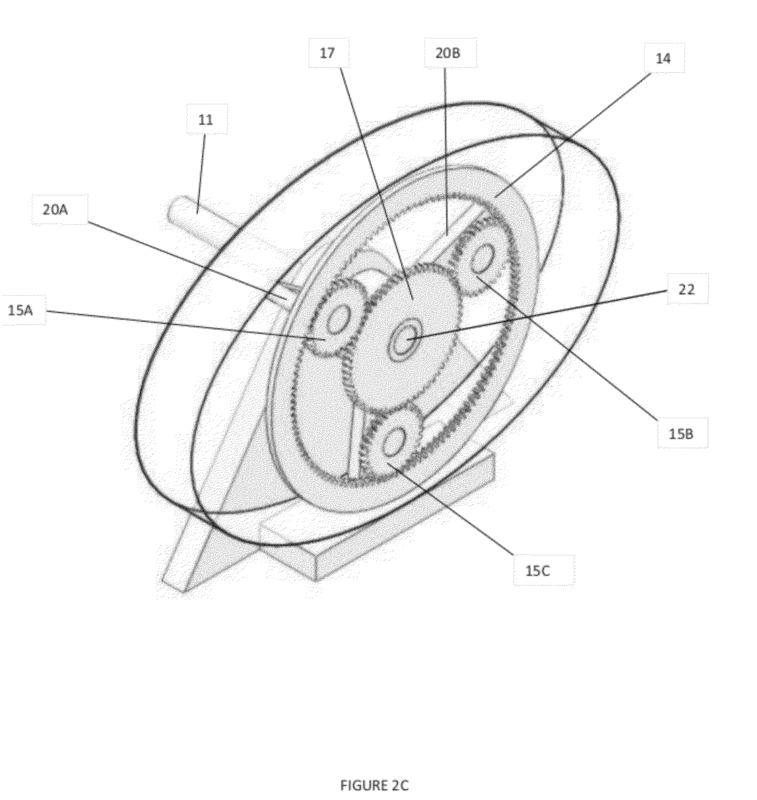

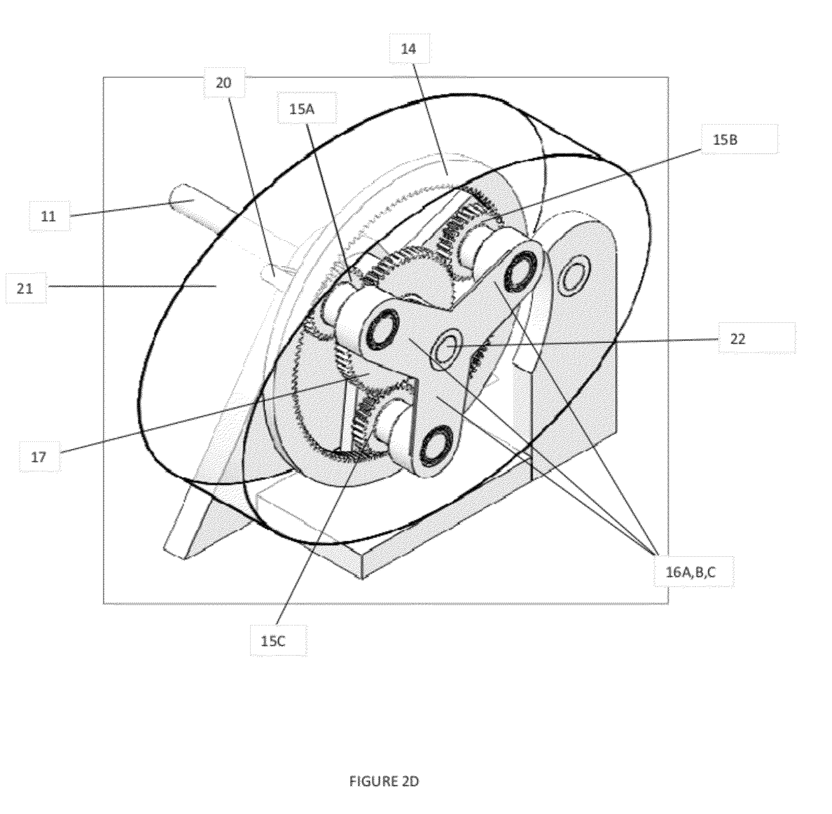

As shown in greater detail in FIG. 2A-2D, a hybrid propulsion system can further include a drive shaft 11, power drive shafts 12 and/or 13 (connected to power sources 1 and 2 as shown in FIG. 1), a planetary gear system (comprising two or more of: a ring gear 14, planetary gear(s) 15, carrier(s) or arm(s) 16, and/or sun gear 17) coupled to a first power source and a second power source, optionally via at least one of the carrier or arms 16 or 20, power drive shafts 12 and/or 13, power gears 18 and/or 19, a drive shaft 11 connected to the planetary gear system and a propulsion mechanism connected to a drive shaft 11. The hybrid propulsion system can optionally further include a power sharing gear assembly having power gears 18, 19, that operably connect the power input from power drive shafts 12 and 13 disposed intermediate of the planetary gear system and the first and second power sources, which couples the first and second power sources to the planetary gear system (comprising two or more of a ring gear 14, planetary gear(s) 15, carrier(s) or arm(s) 16, 20, and/or sun gear 17) which drives the propulsion drive shaft 11. The power drive shaft 12 is operably connected to power sharing gear 19 which rotates power sharing gear 18 operably connected to power drive shaft 13 that delivers torque to the planetary gear system, which delivers power to a propulsion mechanism via the drive shaft 11.

In a further non-limiting embodiment, the hybrid propulsion system can optionally further include a concentric shaft assembly including power drive shafts 12 and 13 disposed intermediate of the planetary gear system and the first and second power sources, which couple the first and second power sources to the planetary gear system (comprising two or more of a ring gear 14, planetary gear(s) 15, carrier(s) or arm(s) 16, 20, and/or sun gear 17). A concentric shaft assembly can include an outer shaft 13 connected to the first power source 2 and an inner shaft 12 connected to the second power source 3. The inner shaft 12 rotates within the outer shaft 13 in connection with the second power source 3, while the outer shaft 13 rotates in connection with the first power source 2. The concentric shaft assembly delivers torque to the planetary gear system, which delivers power to a propulsion mechanism via the drive shaft 11.

A planetary gear system as described herein and known in the art can optionally include planetary gearing having conventional components that are well known in the art. A hybrid propulsion system of the present invention employs either or both of two main components for input, with the remaining component serving as output, thereby providing significant advantages over prior art propulsion systems. Notably, no clutching systems are used, which reduces weight, complexity, and cost. Moreover, the ratios of the gears in the planetary gear system can be designed to optimally accommodate the output speeds of the first power source and the second power source such that the drive shaft rotation is also optimized for efficient propulsion and operation.

As shown in FIG. 1, the first power source 2, which can optionally be an internal combustion engine as power source 1, can optionally be connected to a planet carrier 6 of the planetary gear system, and a second power source 3, which can optionally include an electric motor connected to a sun gear 7 of the planetary gear system. In the embodiment shown in FIG. 1, a ring gear 4 of the planetary gear system can be directly connected to the drive shaft 1, optionally via a carrier 6. In an embodiment wherein the first power source 2 is an internal combustion engine and a second power source 3 is an electric motor, the hybrid propulsion system preserves high efficiency of torque generated by the internal combustion engine.

In operation, when maximum torque may be required, both power sources 2 and 3 simultaneously contribute torque in the hybrid propulsion system, resulting in maximum torque to the drive shaft 1 via the ring gear 4. As the vehicle approaches cruising speed, the power output of the second power source 2 can optionally be gradually reduced. At cruising speed, a second power source 3 can be optionally switched off completely, whereby the torsional resistance of the unpowered second power source 3 can be sufficient to channel all of the rotational power from the first power source 2 to the drive shaft 1. When additional power is needed, the second power source 3 can be used to augment total power to the drive shaft 1.

The hybrid propulsion system is advantageous because it allows, e.g., the use of a light weight first power source 2, e.g. the internal combustion engine, with a small addition of the second power source 3, e.g. the electrical motor, to lower the total weight of an vehicle's propulsion system. A non-limiting embodiment of FIGS. 1 and 2A-D allows power source selection that lowers the weight of an internal combustion engine substantially, which is not offset by the addition of an electric motor plus the planetary gear system. It will be apparent to one of ordinary skill in the art from this disclosure that the electrical energy storage system should be carefully selected to preserve the weight advantage.

Other modes of operation include shutting off the internal combustion engine during operation and allowing the propulsion mechanism powered by the drive shaft to act as both a source of drag and a power generator. Rather than using the propulsion mechanism to merely dissipate energy, the propulsion mechanism can recapture a portion of this energy as the torque is transferred to the electric motor, which in the “off” setting may function as a dynamo. The recaptured energy may then recharge batteries or other electrical energy storage systems.

The hybrid propulsion system also facilitates the use of the propulsion mechanism powered by the drive shaft 1 as a starter for the second power source 2, e.g., as an internal combustion engine, while in use. This can be accomplished by applying low power to the electric motor as the second power source 3 in the reverse setting sufficient to make the torsional resistance of the electric motor shaft greater than that of the internal combustion engine. The power from the propulsion mechanism powered by the drive shaft 1, being turned by the air, water or ground resistance against the propulsion mechanism as the vehicle moves, is transferred to the internal combustion engine shaft, serving as a starter.

With addition of such a braking mechanism on the drive shaft 1, the electric motor can be used directly as a starter motor for the internal combustion engine. When such a drive shaft brake is engaged, all of the torsional energy is transferred via the planetary gear system to the internal combustion engine.

The second power source 3, e.g., as an electric motor, may also be designed to continuously provide a portion of power during cruising speeds, which would allow for additional weight reduction due to a yet smaller first power source 2, e.g., an internal combustion engine. However, to preserve the operating range of the vehicle, increased battery capacity could be provided.

Because the demands on the first power source 2 of torque are considerably less than that of a single power source, various engines may be considered. For instance, diesel engines and small turbine systems could be used, thereby providing advantages of higher energy density of fuel, lower maintenance requirements, and reduced pollution. It is also possible to use two internal combustion engines for the first and second power sources 2,3 and no electric motor, which would still provide operational efficiency advantages. In another embodiment, more than two power sources of torque are utilized by using additional planetary gear systems 6 in serial arrangement.

Aircraft applications. Referring to FIG. 1, a hybrid propulsion system according to an embodiment of a hybrid active clutchless transmission is illustrated generally for an aircraft. The hybrid propulsion system includes at least one first power source 2 and at least one second power source 3. In aircraft design, the need to minimize weight and complexity is important to high efficiency, reliability, and affordability. This invention advantageously mechanically connects two sources of torque (the power sources 2, 3) for simplicity and efficiency. By using two properly sized power sources 2,3 in aircraft, greater total efficiency may be achieved. If the high energy density of conventional fuels or bio fuels is desired, the first power source 2 may be an internal combustion engine. The internal combustion engine can be sized to operate at maximum efficiency providing power sufficient to operate at cruising speed, in level flight and minimizing wear and tear on the internal combustion engine. The second power source 2 preferably provides efficient power over a variable range including power necessary for additional speed, for example, at take-off. When combined with the first power source 2, the second power source 3 meets the power needs for take off and landing and/or for special power requirements needed for situations arising during flight, e.g. turbulence.

The second power source 3 may be either an internal combustion engine or an electrical motor. Electric motors are generally an efficient power source and may be powered by any electrical energy storage system, such as, for example, batteries, photovoltaic cells, fuel cells, flywheels, or combinations thereof.

As shown generally in FIG. 1 and in greater detail in FIGS. 2A-2D, a hybrid propulsion system further includes a planetary gear system (comprising two or more of a ring gear 14, planetary gear(s) 15, carrier(s) or arm(s) 16, 20, and/or sun gear 17) coupled to the first power source 2 and the second power source 3 (FIG. 1) via power drive shafts 12 and 13, a propeller shaft 11 connected to the planetary gear system and a propeller connected to the propeller shaft 11. The hybrid propulsion system can optionally further include a power sharing gear assembly 18, 19, that operably connects the power input from power drive shafts 12 and 13 disposed intermediate of the planetary gear system and the first and second power sources, which couples the first and second power sources to the planetary gear system (comprising two or more of a ring gear 14, planetary gear(s) 15, carrier(s) or arm(s) 16, 20, and/or sun gear 17) which drives the propulsion drive shaft 11. The power drive shaft 12 is operably connected to power sharing gear 19 which rotates power sharing gear 18 operably connected to power drive shaft 13 which delivers torque to the planetary gear system, which delivers power to a propulsion mechanism via the drive shaft 11.

In a further non-limiting embodiment, the hybrid propulsion system can optionally further include a concentric shaft assembly including power drive shafts 12 and 13 disposed intermediate of the planetary gear system and the first and second power sources, which couples the first and second power sources to the planetary gear system (comprising two or more of a ring gear 14, planetary gear(s) 15, carrier(s) or arm(s) 16, 20, and/or sun gear 17). A concentric shaft assembly can include an outer shaft 13 connected to a first power source and an inner shaft 12 connected to a second power source. The inner shaft 12 rotates within the outer shaft 13 in connection with the second power source, while the outer shaft 16 rotates in connection with the first power source. The concentric shaft assembly delivers torque to the planetary gear system, which delivers power to a propulsion mechanism via the drive shaft 11.

The hybrid propulsion system of the present invention employs either or both of two main components for input, with the remaining component serving as output, thereby providing significant advantages over prior art propulsion systems. Notably, no clutching systems are used, which reduces weight, complexity, and cost. Moreover, the ratios of the gears in the planetary gear system can be designed to optimally accommodate the output speeds of the first power source 2 and the second power source 3 such that the propeller shaft rotation is also optimized for efficient flight.

As shown in FIG. 1, the first power source 2, which in the embodiment shown is an internal combustion engine, is connected to a planet carrier 6 of the planetary gear system, and the second power source 3, which comprises an electric motor in the instant embodiment, is connected to a sun gear 7 of the planetary gear system. In the embodiment shown in FIG. 2A-2D, a power drive shaft 13 is connected to the planet carrier 16 and the propeller drive shaft 11 is connected to the ring gear 14A,B via a carrier 20A,B (FIG. 2D).

In one embodiment, wherein the first power source is the internal combustion engine and the second power source is the electric motor, the hybrid propulsion system preserves high efficiency of torque generated by the internal combustion engine. In operation, at take-off, both the internal combustion engine and the electric motor simultaneously contribute torque in the hybrid propulsion system, resulting in maximum rotation of the propeller (i.e. thrust) via the ring gear and the propeller shaf. As the aircraft approaches cruising speed, the power output of the electric motor is gradually reduced. At cruising speed, the electric motor may be switched off completely, whereby the torsional resistance of the unpowered electric motor is sufficient to channel all of the rotational power from the internal combustion engine to the propeller shaft. When additional power is needed, by way of example, in carrying out low speed landing maneuvers, the electric motor can be used to augment total power to the propeller shaft.

The hybrid propulsion system is advantageous because it allows the use of a light weight first power source, e.g. the internal combustion engine, with a small addition of the second power source, e.g. the electrical motor, to lower the total weight of an aircraft's propulsion system. The embodiments of FIGS. 1 and 2A-2D allows power source selection that lowers the weight of the internal combustion engine substantially, which is not offset by the addition of an electric motor plus the planetary gear system. It will be apparent to one of ordinary skill in the art from this disclosure that the electrical energy storage system should be carefully selected to preserve the weight advantage.

Other modes of operation include shutting off the internal combustion engine in flight and allowing the propeller to act as both a source of drag and a wind generator. This can be useful for highly streamlined aircraft during approach and landing maneuvers. Rather than using flaps that merely dissipate energy, the propeller can recapture a portion of this energy as the torque is transferred to the electric motor, which in the “off” setting may function as an alternator, generator, dynamo, or the like. The recaptured energy may then recharge batteries or other electrical energy storage systems.

The hybrid propulsion system also facilitates the use of the propeller as a starter for the internal combustion engine in flight. This may be accomplished by applying low power to the electric motor in the reverse setting sufficient to make the torsional resistance of the electric motor shaft greater than that of the internal combustion engine. The power from the propeller, being turned by the air as the aircraft glides, is transferred to the internal combustion engine shaft, serving as a starter.

With addition of a braking mechanism on the propeller shaft, the electric motor can be used directly as a starter motor for the internal combustion engine. When the propeller shaft brake is engaged, all of the torsional energy is transferred via the planetary gear system to the internal combustion engine. This could be used on the ground or in-flight, though care must be used in flight, as the sudden increase in drag could alter aircraft performance.

The electric motor may also be designed to continuously provide a portion of thrust during cruise, which would allow for additional weight reduction due to a yet smaller internal combustion engine. However, to preserve the operating range of the aircraft, increased battery capacity would be required.

Because the demands on the first power source of torque are considerably less than that of a single power source, various engines may be considered. For instance, diesel engines and small turbine systems could be used, thereby providing advantages of higher energy density of fuel, lower maintenance requirements, and reduced pollution. It is also possible to use two internal combustion engines for the first and second power sources and no electric motor, which would still provide operational efficiency advantages. In another embodiment, more than two power sources of torque are utilized by using additional planetary gear systems in serial arrangement.

A hybrid active clutchless transmission vehicle can include where the propulsion drive shaft driving the propulsion of the vehicle is via one or more of at least one transmission, at least one differential, or at least one other gearing device that operates at angles from 0 to 180 degrees.

A hybrid active clutchless transmission vehicle can include where the propulsion is via at least one propulsion mechanism selected from an aeronautical propeller, a marine propeller, a wheel, or is via a friction or turbulence generating device.

One optional form of propulsion for unmanned and manned aeronautical, marine or amphibious vehicles that can be included for use with a hybrid active clutchless transmission include the use of a propeller or airscrew operably linked to a propulsion drive shaft. A propeller or airscrew comprises a set of small, wing-like aerofoils set around a central hub which spins on an axis aligned in the direction of travel. Spinning the propeller creates aerodynamic lift, or thrust, in a forward direction. A tractor design mounts the propeller in front of the power source, while a pusher design mounts it behind. Although the pusher design allows cleaner airflow over the wing, tractor configuration is more common because it allows cleaner airflow to the propeller and provides a better weight distribution. A contra-prop arrangement has a second propeller close behind the first one on the same axis, which rotates in the opposite direction. A variation on the propeller is to use many broad blades to create a fan. Such fans are traditionally surrounded by a ring-shaped fairing or duct, as ducted fans. Any suitable propeller of airscrew can be used with a hybrid active clutchless transmission, as disclosed herein or as known in the art.

A well-designed propeller typically has an efficiency of around 80% when operating in the best regime. Changes to a propeller's efficiency are produced by a number of factors, notably adjustments to the helix angle(θ), the angle between the resultant relative velocity and the blade rotation direction, and to blade pitch (where θ=φ+α). Very small pitch and helix angles give a good performance against resistance but provide little thrust, while larger angles have the opposite effect. The best helix angle is when the blade is acting as a wing producing much more lift than drag.

A propeller's efficiency is determined by

$$η = \frac{propulsive power out}{shaft power in} = \frac{thrust \cdot axial speed}{resistance torque \cdot rotational speed} .$$

Propellers are similar in aerofoil section to a low drag wing and as such are poor in operation when at other than their optimum angle of attack. Control systems are required to counter the need for accurate matching of pitch to flight speed and engine speed. Further consideration is the number and the shape of the blades used. Increasing the aspect ratio of the blades reduces drag but the amount of thrust produced depends on blade area, so using high aspect blades can lead to the need for a propeller diameter which is unusable. A further balance is that using a smaller number of blades reduces interference effects between the blades, but to have sufficient blade area to transmit the available power within a set diameter means a compromise is needed. Increasing the number of blades also decreases the amount of work each blade is required to perform, limiting the local Mach number—a significant performance limit on propellers. Federal Aviation Administration, Airframe & Powerplant Mechanics Powerplant Handbook U.S Department of Transportation, Jeppesen Sanderson, 1976, the contents of which are entirely incorporated herein by reference.

A clutchless hybrid transmission can comprise one or more planetary or epicyclic gear systems. A gear is a rotating machine part having cut teeth, or cogs, which mesh with another toothed part in order to transmit torque. Two or more gears working in tandem are called a transmission and can produce a mechanical advantage through a gear ratio and thus may be considered a simple machine. Geared devices can change the speed, magnitude, and direction of a power source. The most common situation is for a gear to mesh with another gear, however a gear can also mesh a non-rotating toothed part, called a rack, thereby producing translation instead of rotation. The gears in a transmission are analogous to the wheels in a pulley. An advantage of gears is that the teeth of a gear prevent slipping. When two gears of unequal number of teeth are combined a mechanical advantage is produced, with both the rotational speeds and the torques of the two gears differing in a simple relationship.

In transmissions which offer multiple gear ratios, the term gear, as in first gear, refers to a gear ratio rather than an actual physical gear. The term is used to describe similar devices even when gear ratio is continuous rather than discrete, or when the device does not actually contain any gears, as in a continuously variable transmission.

The gear ratio in an epicyclic or planetary gearing system is somewhat non-intuitive, particularly because there are several ways in which an input rotation can be converted into an output rotation. The three basic components of the epicyclic gear are: Sun: The central gear; Planet carrier: Holds one or more peripheral planet gears, of the same size, meshed with the sun gear; Ring (or ring): An outer ring with inward-facing teeth that mesh with the planet gear or gears. In many epicyclic gearing systems, one of these three basic components is held stationary; one of the two remaining components is an input, providing power to the system, while the last component is an output, receiving power from the system. The ratio of input rotation to output rotation is dependent upon the number of teeth in each gear, and upon which component is held stationary. In hybrid vehicle transmissions, two of the components are used as inputs with the third providing output relative to the two inputs.

One situation is when the planetary carrier is held stationary, and the sun gear is used as input. In this case, the planetary gears simply rotate about their own axes at a rate determined by the number of teeth in each gear. If the sun gear has S teeth, and each planet gear has P teeth, then the ratio is equal to −S/P. For instance, if the sun gear has 24 teeth, and each planet has 16 teeth, then the ratio is −24/16, or −3/2; this means that one clockwise turn of the sun gear produces 1.5 counterclockwise turns of the planet gears. This rotation of the planet gears can in turn drive the ring, in a corresponding ratio. If the ring has A teeth, then the ring will rotate by P/A turns for each turn of the planet gears. For instance, if the ring has 64 teeth, and the planets 16, one clockwise turn of a planet gear results in 16/64, or 1/4 clockwise turns of the ring. Extending this case from the one above: One turn of the sun gear results in −S/P turns of the planets; One turn of a planet gear results in P/A turns of the ring; So, with the planetary carrier locked, one turn of the sun gear results in −S/A turns of the ring.

The ring may also be held fixed, with input provided to the planetary gear carrier; output rotation is then produced from the sun gear. This configuration will produce an increase in gear ratio, equal to 1+A/S. These are all described by the equation: (2+n)ωa+nωs−2(1+n)ωc=0, where n is the form factor of the planetary gear, defined by:

If the ring is held stationary and the sun gear is used as the input, the planet carrier will be the output. The gear ratio in this case will be 1/(1+A/S). This is the lowest gear ratio attainable with an epicyclic gear train. This type of gearing is sometimes used in tractors and construction equipment to provide high torque to the drive wheels.

Gear Materials: Any suitable material can be used for gears in a hybrid active clutchless transmission. Non-limiting examples include numerous metals, nonferrous alloys, cast irons, powder-metallurgy and plastics can used in the manufacture of gears. However steels are most commonly used because of their high strength to weight ratio and low cost. Plastic is commonly used where cost or weight is a concern. A properly designed plastic gear can replace steel in many cases because it has many desirable properties, including dirt tolerance, low speed meshing, and the ability to “skip” quite well.

Gears are most commonly produced via hobbing, but they are also shaped, broached, cast, and in the case of plastic gears, injection molded. For metal gears the teeth are usually heat treated to make them hard and more wear resistant while leaving the core soft and tough. For large gears that are prone to warp a quench press is used.

A transmission or gearbox provides speed and torque conversions from a rotating power source to another device using gear ratios. In British English the term transmission refers to the whole drive train, including gearbox, clutch, prop shaft (for rear-wheel drive), differential and final drive shafts. The most common use is in motor vehicles, where the transmission adapts the output of the internal combustion engine to the drive wheels. Such engines need to operate at a relatively high rotational speed, which is inappropriate for starting, stopping, and slower travel. The transmission reduces the higher engine speed to the slower wheel speed, increasing torque in the process. Transmissions are also used on pedal bicycles, fixed machines, and anywhere else rotational speed and torque needs to be adapted. Often, a transmission will have multiple gear ratios (or simply “gears”), with the ability to switch between them as speed varies. This switching may be done manually (by the operator), or automatically. Directional (forward and reverse) control may also be provided. Single-ratio transmissions also exist, which simply change the speed and torque (and sometimes direction) of motor output. In motor vehicle applications, the transmission will generally be connected to the propulsion shaft of the engine. The output of the transmission is transmitted via driveshaft to one or more differentials, which in turn drive the wheels, propeller, or other propulsion device. While a differential may also provide gear reduction, its primary purpose is to change the direction of rotation.

A clutchless hybrid transmission system can optionally comprise at least one sun gear, at least one planetary gear, and at least one ring gear. One or more sun gears and/or ring gears can be directly linked to at least one planetary gear. Each sun gear can be linked to each set of planetary gears. Each sun gear can be linked via each set of planetary gears to a ring gear. A set of planetary gears can be in the same plane as the linked sun gear and/or ring gear. The planetary gear set can comprise 2, 3, 4, 5, 6, 7, or 8 planetary gears in the same or different plane. The INSERT

A set of planetary gears can be operably linked to at least one drive shaft, such as at least one propulsion drive shaft or at least one power driveshaft. A ring gear can be operably linked to at least one drive shaft, such as at least one propulsion drive shaft or at least one power driveshaft. A sun gear can be operably linked to at least one drive shaft, such as at least one propulsion drive shaft or at least one power driveshaft.

A set of planetary gears can be linked via at least one carrier or arm to at least one drive shaft, such as at least one propulsion drive shaft or at least one power driveshaft. A ring gear can be linked via at least one carrier or arm to at least one drive shaft, such as at least one propulsion drive shaft or at least one power driveshaft. A sun gear can be linked via at least one carrier or arm to at least one drive shaft, such as at least one propulsion drive shaft or at least one power driveshaft.

A clutchless hybrid transmission system can optionally comprise at least one carrier or arm operably connected to at least one of the at least one sun gear, at least one planetary gear, and at least one ring gear.

A clutchless hybrid transmission system can optionally comprise wherein at least one of the at least one propulsion drive shaft is connected to one of the at least one sun gear, at least one planetary gear, and at least one ring gear.

A clutchless hybrid transmission system can optionally comprise wherein the connection is via the at least one carrier or arm.

A clutchless hybrid transmission system can optionally comprise wherein the propulsion drive shaft is connected to the ring gear via the carrier or arm and the at least two sources of power are connected via dual power drive shafts that are separate or concentric and each drive a different of the planetary gear and the sun gear that drive the propulsion drive shaft of the propulsion system. A clutchless hybrid transmission system can optionally further include, wherein the ratio of the at least one planetary gear and the at least one sun gear is between about 0.2 and about 0.8, e.g., but not limited to, 0.2, 0.3, 0.4., 0.5, 0.6., 0.7., 0.8, 0.9, or any range or value therein, e.g., + or −0.01, 0.02., 0.03, 0.04., 0.05., 0.06, 0.07, 0.08, 0.09, 0.001, 0.002, 0.003, 0.004, 0.005., 0.006, 0.007, 0.008, 0.009, 0.0001, such as but not limited to 0.4-0.6, 0.3-0.8, 0.41-0.59, 0.45-0.55, 0.47-0.53, 0.49-0.51, or any range or value therein.

A clutchless hybrid transmission system can optionally further include, wherein the ratio of the at least one planetary gear and the at least one sun gear is about 0.5.

A clutchless hybrid transmission system can optionally further include, wherein the at least one planetary or epicyclic gearing system provides simultaneous power coupling between at least two sources of power and at least one propulsion drive shaft of the hybrid propulsion system.

A clutchless hybrid transmission system can optionally further include, at least one battery or electrical storing system that powers the EM.

A clutchless hybrid transmission system can optionally further include, wherein the ICE charges the battery or electrical storing system.

A clutchless hybrid transmission system can optionally further include, wherein the ICE and EM power the drive shaft simultaneously as a mechanically additive system.

A method is also provided for transferring power from at least two power sources to at least one propulsion drive shaft in a vehicle, comprising (a) providing a hybrid propulsion system comprising at least one clutchless hybrid transmission system comprising at least one planetary or epicyclic gearing system that provides alternating or simultaneous power coupling between the at least two sources of power and the at least one propulsion drive shaft of the hybrid propulsion system.

PLANETARY GEARS: A planetary gearbox that can optionally be used in a clutchless hybrid transmission can comprise three stages of gears, any of which can either be an input or an output. One planetary gear option is the multi ratio planetary gear in which the planet gears have multiple ratios allowing for either an additional gear ratio within the box or an addition input/output. The other planetary gearing system is the standard planetary gear in which the planets consist of only one gear size. A planetary gearing system (also known as an epicyclic) is composed of three sets of gears; a large internal gear surrounding the others, a single standard spur gear in the center, and typically two to four spur gears spanning the space between the other two. The standard naming technique for the system is planetary in nature. The internal gear is labeled the ring gear, the center gear is labeled the sun gear and the gears spanning the space are labeled planet gears. The planet gears are held together with a structure labeled carrier (also arm).

A first governing equation for the planetary system is the RPM relation.

$$R = \frac{{N}_{sun}}{{N}_{ring}} = \frac{{ω}_{carrier} - {ω}_{ring}}{{ω}_{sun} - {ω}_{carrier}}$$

Where R is the gear ratio, N is the number of teeth, and ω is the angular velocity.

A equation can be rearranged into another useful form:

Nₛᵤₙ·ωₛᵤₙ+N_{ring}·ω_{ring}=(N_{ring}+Nₛᵤₙ)·ω_{carrier}→R·ωₛᵤₙ+ω_{ring}=(1+R)·ωₐᵣₘ

A gear ratio can be further defined. Since the planet and sun gears must fit into the ring gear a simple summation is produced.

Nₛᵤₙ+2Nₚₗₐₙₑₜ=N_{ring}

A second governing equation for the planetary system is the torque equation which is derived from the power equation.

Pₒᵤₜ=(Pᵢₙ₁+Pᵢₙ₂)·η

P=τ·ω

Where is P the power, η is the efficiency of the gearbox, τ is the torque, and ω is the angular velocity. This equation is used to find the power and output (the propeller).

Since the planetary system allows for at least three components, the system must be well defined for maximum efficiency. Each component can be attached to any of the mechanical systems (example: ring can be attached to the propeller, EM or ICE). Also since the gear ratio can be set the system is very dynamic. A gear ratio can be selected depending on the desired characteristics of the propulsion system, where each component, such as propulsion drive shaft, power supply 1 and power supply 2, can be attached each to one of a ring gear, a ring gear carrier, a sun gear, a sun gear carrier, a planet carrier or arm, or a planet gear.

Power Sources. Alternative “hybrid propulsion systems” are also provided that can comprise at least one clutchless hybrid transmission system and at least two sources of power operably linked to a propulsion drive shaft. Non-limiting examples of the at least two sources of power can comprise at least one of any type of internal combustion engine (ICE) and any type of at least one electric motor (EM). Such sources of power can also or alternatively include any other form of suitable power source, e.g., but not limited to, fuel cells, solar power (e.g., photovoltaic and the like), steam engines, and the like.

An internal combustion engine is an engine in which the combustion of a fuel (which can be, but is not limited to, a fossil fuel or hydrocarbon) occurs with an oxidizer (usually air or other combustible/gas or gas mixture) in a combustion chamber. In an internal combustion engine the expansion of the high-temperature and -pressure gases produced by combustion applies direct force to some component of the engine, such as pistons, turbine blades, or a nozzle. This force moves the component over a distance, generating useful mechanical energy.

The term internal combustion engine can include, but is not limited to, an engine in which combustion is intermittent or semi continuous, such as four-stroke, two-stroke, five stroke, or six stroke, piston engines, along with any known variants, such as, but not limited to, a Wankel rotary engine or other known type of engine. A second class of internal combustion engines use continuous combustion, e.g., but not limited to, gas turbines, jet engines and most rocket engines, each of which are internal combustion engines on the same principle as previously described.

The internal combustion engine (or ICE) is different from external combustion engines (or ECE), such as steam or Stirling engines, in which the energy is delivered to a working fluid not consisting of, mixed with, or contaminated by combustion products. Working fluids can include, but are not limited to, air, a gas, water, pressurized water, or any suitable liquid, heated in some kind of boiler or other suitable device.

A large number of different designs for ICEs have been developed and built, with a variety of different characteristics, strengths and/or weaknesses. Powered by an energy-dense fuel (e.g., but not limited to, ethanol, diesel, petrol or gasoline, a liquid derived from fossil fuels), the ICE delivers an excellent power-to-weight ratio with few disadvantages. While there have been and still are many stationary applications, the real strength of internal combustion engines is in mobile applications and they dominate as a power supply for vehicles, such as, but not limited to, land, air, and marine, or amphibious, vehicles, or combinations thereof.

Accordingly, any suitable ICE, ECE, or electric motor (EM) can be used herein for providing power as a power source any suitable vehicle comprising a hybrid active clutchless transmission as described herein.

Electric motors (EM) can be used, including any suitable EM. An EM is any machine that converts electricity into a mechanical motion. An AC motor is an electric motor that is driven by alternating current, which can include, but is not limited to, (i) a synchronous motor, an alternating current motor distinguished by a rotor spinning with coils passing magnets at the same rate as the alternating current and resulting magnetic field which drives it; or (ii) an induction motor (also called a squirrel-cage motor) a type of asynchronous alternating current motor where power is supplied to the rotating device by means of electromagnetic induction. A DC motor is an electric motor that runs on direct current electricity, which can include, but is not limited to, (i) a brushed DC electric motor, an internally commutated electric motor designed to be run from a direct current power source; and (ii) a brushless DC motor, a synchronous electric motor, which is powered by direct current electricity and has an electronically controlled commutation system, instead of a mechanical commutation system based on brushes.

Vehicles: Any suitable vehicle can use a hybrid active clutchless transmission, wherein the vehicle can include, but is not limited to, an unmanned aeronautical vehicle, a manned aeronautical vehicle, an inboard marine vehicle, an outboard marine vehicle, a two wheeled land or amphibious vehicle, a multi-wheeled land or amphibious vehicle, or any combination thereof.

Non-limiting examples of vehicles that can be used with a hybrid active clutchless transmission include aeronautical vehicles or aircraft, such as unmanned aerial vehicles, unmanned aircraft systems, manned aircraft,

Aircraft. Any suitable aeronautical vehicle or aircraft can use a hybrid active clutchless transmission, wherein the vehicle can include, but is not limited to, an unmanned aeronautical vehicle, or a manned aeronautical vehicle, as known in the art or as described herein. An aeronautical vehicle or aircraft is a vehicle which is able to fly by being supported by the air, or in general, the atmosphere of a planet. An aircraft counters the force of gravity by using either static lift or by using the dynamic lift of an airfoil, or in a few cases the downward thrust from jet engines. Any suitable aeronautical vehicle or aircraft can be used with a clutchless hybrid transmission.

Heavier than air—aerodynes suitable for use with a hybrid active clutchless transmission can include any type with at least two power sources. Heavier-than-air aircraft must find some way to push air or gas downwards, so that a reaction occurs (by Newton's laws of motion) to push the aircraft upwards. This dynamic movement through the air is the origin of the term aerodyne. There are two ways to produce dynamic upthrust: aerodynamic lift, and powered lift in the form of engine thrust. Aerodynamic lift is the most common, with fixed-wing aircraft being kept in the air by the forward movement of wings, and rotorcraft by spinning wing-shaped rotors sometimes called rotary wings. A wing is a flat, horizontal surface, usually shaped in cross-section as an aerofoil. To fly, air must flow over the wing and generate lift. A flexible wing is a wing made of fabric or thin sheet material, often stretched over a rigid frame.

With powered lift, the aircraft directs its engine thrust vertically downwards. The initialism VTOL (vertical take off and landing) is applied to aircraft that can take off and land vertically. Most are rotorcraft. Others take off and land vertically using powered lift and transfer to aerodynamic lift in steady flight. Similarly, STOL stands for short take off and landing. Some VTOL aircraft often operate in a short take off/vertical landing mode known as STOVL.

Fixed-wing. Besides the method of propulsion, fixed-wing aircraft are generally characterized by their wing configuration. The most important wing characteristics are: Number of wings—Monoplane, biplane, etc; Wing support—Braced or cantilever, rigid or flexible; Wing planform—including aspect ratio, angle of sweep and any variations along the span (including the important class of delta wings); Location of the horizontal stabilizer, if any; Dihedral angle—positive, zero or negative (anhedral).

A variable geometry aircraft can change its wing configuration during flight. A flying wing has no fuselage, though it may have small blisters or pods. The opposite of this is a lifting body which has no wings, though it may have small stabilising and control surfaces. Most fixed-wing aircraft feature a tail unit or empennage incorporating vertical, and often horizontal, stabilising surfaces. Seaplanes are aircraft that land on water, and they fit into two broad classes: Flying boats are supported on the water by their fuselage. A float plane's fuselage remains clear of the water at all times, the aircraft being supported by two or more floats attached to the fuselage and/or wings. Some examples of both flying boats and float planes are amphibious, being able to take off from and alight on both land and water. Some consider wing-in-ground-effect vehicles to be fixed-wing aircraft, others do not. These craft “fly” close to the surface of the ground or water. Man-powered aircraft also rely on ground effect to remain airborne, but this is only because they are so underpowered—the airframe is theoretically capable of flying much higher.

Rotorcraft, or rotary-wing aircraft, use a spinning rotor with aerofoil section blades (a rotary wing) to provide lift. Types include helicopters, autogyros and various hybrids such as gyrodynes and compound rotorcraft. Helicopters have powered rotors. The rotor is driven (directly or indirectly) by an engine and pushes air downwards to create lift. By tilting the rotor forwards, the downwards flow is tilted backwards, producing thrust for forward flight. Autogyros or gyroplanes have unpowered rotors, with a separate power plant to provide thrust. The rotor is tilted backwards. As the autogyro moves forward, air blows upwards across the rotor, making it spin.(cf. Autorotation) This spinning dramatically increases the speed of airflow over the rotor, to provide lift.

Gyrodynes are a form of helicopter, where forward thrust is obtained from a separate propulsion device rather than from tilting the rotor. The definition of a ‘gyrodyne’ has changed over the years, sometimes including equivalent autogyro designs. The Heliplane is a similar system.

Compound rotorcraft have wings which provide some or all of the lift in forward flight. Compound helicopters and compound autogyros have been built, and some forms of gyroplane may be referred to as compound gyroplanes. They are nowadays classified as powered lift types and not as rotorcraft. Tiltrotor aircraft have their rotors horizontal for vertical flight, and pivot the rotors vertically like a propeller for forward flight. Some rotorcraft have reaction-powered rotors with gas jets at the tips, but most have one or more lift rotors powered from engine-driven shafts.

Unmanned aerial vehicles or unmanned aircraft systems suitable for use with a hybrid active clutchless transmission can include any type with at least two power sources. An unmanned aerial vehicle (UAV); also known as a remotely piloted vehicle or RPV, or Unmanned Aircraft System (UAS), is an aircraft that is flown by a pilot or a navigator (now called combat systems officer) depending on the different Air Forces, however, without a human crew on board the aircraft. To distinguish UAVs from missiles, a UAV is defined as a reusable, remotely crewed aircraft capable of controlled, sustained, level flight and powered by a jet, reciprocating engine, or other sources of propulsion. There are a wide variety of UAV shapes, sizes, configurations, and characteristics. UAVs come in two varieties: some are controlled from a remote location, and others fly autonomously based on pre-programmed flight plans using more complex dynamic automation systems. Currently, military UAVs perform reconnaissance as well as attack missions. UAVs are also used in civil applications, such as firefighting or nonmilitary security and other work, such as surveillance. The abbreviation UAV has been expanded in some cases to UAVS (unmanned-aircraft vehicle system). In the United States, the Federal Aviation Administration has adopted the generic class unmanned aircraft system (UAS) originally introduced by the U.S. Navy to reflect the fact that these are not just aircraft, but systems, including ground stations and other elements. Wagner, William. Lightning Bugs and other Reconnaissance Drones; The can-do story of Ryan's unmanned spy planes. 1982, Armed Forces Journal International, in cooperation with Aero Publishers, Inc., entirely incorporated herein by reference.

Although most UAVs are fixed-wing aircraft, rotorcraft designs such as this MQ-8B Fire Scout can also be used. UAVs typically fall into one of six functional categories (although multi-role airframe platforms are becoming more prevalent): (i) Target and decoy—providing ground and aerial gunnery a target that simulates an enemy aircraft or missile; (ii) Reconnaissance—providing battlefield intelligence; (iii) Combat—providing attack capability for high-risk missions (see Unmanned combat air vehicle); (iv) Logistics—UAVs specifically designed for cargo and logistics operation; (v) Research and development—used to further develop UAV technologies to be integrated into field deployed UAV aircraft; and (vi) Civil and Commercial UAVs—UAVs specifically designed for civil and commercial applications. UAVs can also be categorized in terms of range/altitude and the following has been advanced as relevant at such industry events as Parc Aberporth Unmanned Systems forum: (a) Handheld 2,000 ft (600 m) altitude, about 2 km range; (b) Close 5,000 ft (1,500 m) altitude, up to 10 km range; (c) NATO type 10,000 ft (3,000 m) altitude, up to 50 km range; (d) Tactical 18,000 ft (5,500 m) altitude, about 160 km range; (e) MALE (medium altitude, long endurance) up to 30,000 ft (9,000 m) and range over 200 km; and (f) HALE (high altitude, long endurance) over 30,000 ft (9,100 m) and indefinite range.

In a third classification system, the modern concept of U.S. military UAVs is to have the various aircraft systems work together in support of personnel on the ground. The integration scheme is described in terms of a “Tier” system, and is used by military planners to designate the various individual aircraft elements in an overall usage plan for integrated operations. The Tiers do not refer to specific models of aircraft, but rather roles for which various models and their manufacturers competed. The U.S. Air Force and the U.S. Marine Corps each has its own tier system, and the two systems are themselves not integrated.

UAS, or unmanned aircraft system, is the official United States Federal Aviation Administration (FAA) term for an unmanned aerial vehicle. The inclusion of the term aircraft emphasizes that regardless of the location of the pilot and flight crew, the operations must comply with the same regulations and procedures as do those aircraft with the pilot and flight crew onboard. The official acronym ‘UAS’ is also used by International Civil Aviation Organization (ICAO) and other government aviation regulatory organizations.

UAVs perform a wide variety of functions. The majority of these functions are some form of remote sensing; this is central to the reconnaissance role most UAVs fulfill. UAV functions can also include interaction and transport. UAV remote sensing functions include electromagnetic spectrum sensors, biological sensors, and chemical sensors. A UAV's electromagnetic sensors typically include visual spectrum, infrared, or near infrared cameras as well as radar systems. Other electromagnetic wave detectors such as microwave and ultraviolet spectrum sensors may also be used. Biological sensors are sensors capable of detecting the airborne presence of various microorganisms and other biological factors. Chemical sensors use laser spectroscopy to analyze the concentrations of each element in the air.

UAVs can transport goods using various means based on the configuration of the UAV itself. Most payloads are stored in an internal payload bay somewhere in the airframe. For many helicopter configurations, external payloads can be tethered to the bottom of the airframe. With fixed wing UAVs, payloads can also be attached to the airframe, but aerodynamics of the aircraft with the payload must be assessed. For such situations, payloads are often enclosed in aerodynamic pods for transport.

As a non-limiting example of scientific research, the RQ-7 Shadow is capable of delivering a 20 lb (9.1 kg) medical or other supply canister or payload to front-line troops. Unmanned aircraft are uniquely capable of penetrating areas which may be too dangerous for piloted craft. The National Oceanic and Atmospheric Administration (NOAA) began utilizing the Aerosonde unmanned aircraft system in 2006 as a hurricane hunter. AAI Corporation subsidiary Aerosonde Pty Ltd. of Victoria (Australia), designs and manufactures the 35-pound system, which can fly into a hurricane and communicate near-real-time data directly to the National Hurricane Center in Florida.

As non-limiting examples of search and rescue, UAVs can be used, e.g., the successful use of UAVs during the 2008 hurricanes that struck Louisiana and Texas, and Predators, operating between 18,000-29,000 feet above sea level, performed search and rescue and damage assessment. Payloads carried were an optical sensor (which is a daytime and infra red camera) and a synthetic aperture radar. The Predator's SAR is a sophisticated all-weather sensor capable of providing photographic-like images through clouds, rain or fog, and in daytime or nighttime conditions; all in real-time.

As a non-limiting example of endurance applications, RQ-4 Global Hawk, a high-altitude reconnaissance UAV capable of 36 hours continuous flight time. Because UAVs are not burdened with the physiological limitations of human pilots, they can be designed for maximized on-station times. The maximum flight duration of unmanned, aerial vehicles varies widely. Internal-combustion-engine aircraft endurance depends strongly on the percentage of fuel burned as a fraction of total weight (the Breguet endurance equation), and so is largely independent of aircraft size. Solar-electric UAVs can be used to complement ICE powered flight using a hybrid active clutchless transmission.

Manned aeronautical vehicles. Manned aircraft included in aeronautical vehicles include any aircraft that can use a hybrid active clutchless transmission with at least two power sources. Non-limiting examples of such aircraft include fixed wing, rotocraft, rotory wing, and any other type of manned aeronautical vehicle.

Aircraft engines suitable for use with a hybrid active clutchless transmission can include any suitable aircraft engine as a power source for a propulsion drive shaft that is driven by at least two power sources operably linked to thehybrid active clutchless transmission. The process of developing an engine is one of compromises. Engineers design specific attributes into engines to achieve specific goals. Aircraft are one of the most demanding applications for an engine, presenting multiple design requirements, many of which conflict with each other. An aircraft engine must be: (i) reliable, as losing power in an airplane is a substantially greater problem than in an automobile. Aircraft engines operate at temperature, pressure, and speed extremes, and therefore need to perform reliably and safely under all reasonable conditions; (ii) light weight, as a heavy engine increases the empty weight of the aircraft and reduces its payload; (iii) powerful, to overcome the weight and drag of the aircraft; (iv) small and easily streamlined; large engines with substantial surface area, when installed, create too much drag; (v) field repairable, to keep the cost of replacement down; (vi) fuel efficient to give the aircraft the range the design requires; and (vii) capable of operating at sufficient altitude for the aircraft.

Aircraft spend the vast majority of their time travelling at high speed. This allows an aircraft engine to be air cooled, as opposed to requiring a radiator. With the absence of a radiator, aircraft engines can boast lower weight and less complexity. The amount of air flow an engine receives is usually designed according to expected speed and altitude of the aircraft in order to maintain the engine at the optimal temperature. Aircraft operate at higher altitudes where the air is less dense than at ground level. As engines need oxygen to burn fuel, a forced induction system such as turbocharger or supercharger is appropriate for aircraft use. This does bring along the usual drawbacks of additional cost, weight and complexity.

V engines. Cylinders in this engine are arranged in two in-line banks, tilted 30-60 degrees apart from each other. The vast majority of V engines are water-cooled. The V design provides a higher power-to-weight ratio than an inline engine, while still providing a small frontal area.

Radial engines. This type of engine has one or more rows of cylinders arranged in a circle around a centrally-located crankcase. Each row must have an odd number of cylinders in order to produce smooth operation. A radial engine has only one crank throw per row and a relatively small crankcase, resulting in a favorable power to weight ratio. Because the cylinder arrangement exposes a large amount of the engine's heat radiating surfaces to the air and tends to cancel reciprocating forces, radials tend to cool evenly and run smoothly.

Flat engine. An opposed-type engine has two banks of cylinders on opposite sides of a centrally located crankcase. The engine is either air cooled or liquid cooled, but air cooled versions predominate. Opposed engines are mounted with the crankshaft horizontal in airplanes, but may be mounted with the crankshaft vertical in helicopters. Due to the cylinder layout, reciprocating forces tend to cancel, resulting in a smooth running engine. Unlike a radial engine, an opposed engine does not experience any problems with hydrostatic lock. Opposed, air-cooled four and six cylinder piston engines are by far the most common engines used in small general aviation aircraft requiring up to 400 horsepower (300 kW) per engine.

Marine vehicles. A marine vehicle suitable for use with a hybrid active clutchless transmission can include any type of suitable boat. A boat is a watercraft designed to float or plane, to provide passage of people, animals, and/or payloads across water. This water can be inland, coastal, or at sea. In naval terms, a boat is something small enough to be carried aboard another vessel (a ship). Strictly speaking and uniquely a submarine is a boat as defined by the Royal Navy.

Non-limiting examples of marine vehicles include any inboard or outboard powered boat or amphibious vehicle, comprising at least two power sources, including ICEs, EM, or other power source. Specific non-limiting examples include, but are not limited to, one or more of the following: airboat, ambulance, banana boat, barge, bass boat, bow rider, cabin cruiser, car-boat, catamaran, clipper ship, cruise ship, cruiser, cruising trawler, dinghy, dory, dragger, dredge, drifter (fishing), drifter (naval), ferry, fishing boat, houseboat, hydrofoil, hydroplane, jetboat, jet ski, launch, landing craft, longboat, luxury yacht, motorboat, motor launch (naval), personal water craft (pwc), pleasure barge, powerboat, riverboat, runabout, rowboat, sailboat, schooner, scow, sharpie, ship, ski boat, skiff, steam boat, slipper launch, sloop, speed boat, surf boat, swift boat, traditional fishing boats, trimaran, trawler (fishing), trawler (naval), trawler (recreational), tugboat, wakeboard boat, water taxi, whaleboat, yacht, and/or yawl.

Boat or marine vehicle propulsion can include any suitable type used with a hybrid active clutchless transmission with at least two power sources, such as with an EM, but are not limited to, motor powered screws, inboard (such as internal combustion (e.g, but not limited to, gasoline, diesel, heavy fuel oil) steam (coal, fuel oil), nuclear (for submarines and large naval ships), inboard/outboard (e.g, but not limited to, gasoline, electric, steam and diesel), outboard (e.g, but not limited to, gasoline, electric, steam and diesel), electric, paddle wheel, and water jet (e.g, but not limited to, personal water craft, jetboats). See, e.g., McGrail, Sean (2001). Boats of the World. Oxford, UK: Oxford University Press. ISBN 0-19-814468-7, entirely incorporated herein by reference.

Inboard Motors: An inboard motor is a marine propulsion system for boats. As opposed to an outboard motor where an engine is mounted outside of the hull of the craft, an inboard motor is an engine enclosed within the hull of the boat, usually connected to a propulsion screw by a drive shaft. Sizes: Inboard motors may be of several types, suitable for the size of craft they are fitted to. Boats can use one cylinder to v12 engines, depending if they are used for racing or trolling. Small craft. For pleasure craft, such as sailboats and speedboats, both diesel and gasoline engines are used. Many inboard motors are derivatives of automobile engines, known as marine automobile engines. The advent of the stern drive propulsion leg improved design so that auto engines could easily power boats. Large craft: For larger craft, including ships (where outboard propulsion would in any case not be suitable) the propulsion system may include many types, such as diesel, gas turbine, or even fossil-fuel or nuclear-generated steam. Some early models used coal for steam-driven ships. Cooling. Aircraft engines were later used in boats. Some inboard motors are freshwater cooled, while others have a raw water cooling system where water from the lake, river or sea is pumped by the engine to cool it. However, as seawater is corrosive, and can damage engine blocks and cylinder heads, some seagoing craft have engines which are indirectly cooled via a heat exchanger. Other engines, notably small single and twin cylinder diesels specifically designed for marine use, use raw seawater for cooling and zinc sacrificial anodes are employed protect the internal metal castings.

A stern drive or inboard/outboard drive (I/O) is another suitable form of marine propulsion for use with an additional power source, such as an EM. The engine is located inboard just forward of the transom (stern) and provides power to the drive unit located outside the hull. This drive unit (or outdrive) resembles the bottom half of an outboard motor, and is composed of two sub-units: the upper unit contains a drive shaft that connects through the transom to the engine and transmits power to a 90-degree-angle gearbox; the lower unit bolts onto the bottom of the upper unit and contains a vertical drive shaft that transmits power from the upper unit gearbox down to another 90-degree-angle gearbox in the lower unit, which connects to the propeller shaft. Thus, the outdrive carries power from the inboard engine, typically mounted above the waterline, outboard through the transom and downward to the propeller below the waterline. The outdrive can be matched with a variety of engines in the appropriate power range; upper and lower units can often be purchased separately to customize gear ratios and propeller RPM, and lower units are also available with counter-rotating gearing to provide balanced torque in dual-drive installations. The boat is steered by pivoting the outdrive, just like with an outboard motor, and no rudder is needed. The engine itself is usually the same as those used in true inboard systems, historically the most popular in North America was marinized versions of Chevrolet and Ford V-8 automotive engines. In Europe diesel engines are more popular with up to 370 hp available with Volvo Pentas D6A-370. Brands of sterndrive include Volvo Penta (part of the Volvo Group) and MerCruiser (produced by Brunswick Corporation's Mercury Marine, which also manufactures outboard motors). Advantages of the sterndrive system versus outboards include higher available horsepower per engine and a clean transom with no cutouts for the outboard installation and no protruding powerhead, which makes for easier ingress and egress for pleasure boat passengers and for easier fishing. Advantages of the sterndrive system versus inboards include simpler engineering for boatbuilders, eliminating the need for them to design propshaft and rudder systems; also, a significant space savings with the engine mounted all the way aft, freeing up the boat's interior volume for occupancy space.

An outboard motor is a propulsion system for boats that can be used as a power source for hybrid active clutchless transmission, consisting of a self-contained unit that includes engine, gearbox and propeller or jet drive, designed to be affixed to the outside of the transom and are the most common motorized method of propelling small watercraft. As well as providing propulsion, outboards provide steering control, as they are designed to pivot over their mountings and thus control the direction of thrust. The skeg also acts as a rudder when the engine is not running. Compared to inboard motors, outboard motors can be easily removed for storage or repairs. When boats are out of service or being drawn through shallow waters, outboard motors can be tilted up (tilt forward over the transom mounts) to elevate the propeller and lower unit out of the water to avoid accumulation of seaweed, underwater hazards such as rocks, and to clear road hazards while trailering. Small outboard motors, up to 15 horsepower or so are easily portable. They are affixed to the boat via clamps, and thus easily moved from boat to boat. These motors typically use a manual pull start system, with throttle and gearshift controls mounted on the body of the motor, and a tiller for steering. The smallest of these can weigh as little as 12 kilograms (26 lb), have integral fuel tanks, and provide sufficient power to move a small dinghy at around 8 knots (15 km/h; 9.2 mph) This type of motor is typically used: to power small craft such as jon boats, dinghies, canoes, etc; to provide auxiliary power for sailboats; for trolling aboard larger craft, as small outboards are typically more efficient at trolling speeds. In this application, the motor is frequently installed on the transom alongside and connected to the primary outboard to enable helm steering. Large outboards are usually bolted to the transom (or to a bracket bolted to the transom), and are linked to controls at the helm. These range from 2-3- and 4-cylinder models generating 15 to 135 horsepower suitable for hulls up to 17 feet (5.2 m) in length, to powerful V-6 and V-8 cylinder blocks rated up to 350 hp (260 kW), with sufficient power to be used on boats of 18 feet (5.5 m) or longer. Electric-Powered motors are commonly referred to as “trolling motors” or “electric outboard motors”, electric outboards can be used as a power source for a hybrid active clutchless transmission, e.g., but not limited to, small craft or on small lakes, as a secondary means of propulsion on larger craft, and as repositioning thrusters while fishing for bass and other freshwater species, and any other application where their quietness, and ease of operation and zero emissions outweigh the speed and range deficiencies. Diesel outboards are also available but their weight and cost make them rare. Pump-jet propulsion is available as an option on most outboard motors. Although less efficient than an open propeller, they are particularly useful in applications where the ability to operate in very shallow water is important. They also eliminate the laceration dangers of an open propeller.

Operational Considerations. Motor mounting height on the transom is an important factor in achieving optimal performance. The motor should be as high as possible without ventilating or loss of water pressure. This minimizes the effect of hydrodynamic drag while underway, allowing for greater speed. Generally, the anti-ventilation plate should be about the same height as, or up to two inches higher than, the keel, with the motor in neutral trim. Trim is the angle of the motor in relation to the hull, as illustrated below. The ideal trim angle is the one in which the boat rides level, with most of the hull on the surface instead of plowing through the water. If the motor is trimmed out too far, the bow will ride too high in the water. With too little trim, the bow rides too low. The optimal trim setting will vary depending on many factors including speed, hull design, weight and balance, and conditions on the water (wind and waves). Many large outboards are equipped with power trim, an electric motor on the mounting bracket, with a switch at the helm that enables the operator to adjust the trim angle on the fly. In this case, the motor should be trimmed fully in to start, and trimmed out (with an eye on the tachometer) as the boat gains momentum, until it reaches the point just before ventilation begins or further trim adjustment results in an RPM increase with no increase in speed. Motors not equipped with power trim are manually adjustable using a pin called a topper tilt lock. Ventilation is a phenomenon that occurs when surface air or exhaust gas (in the case of motors equipped with through-hub exhaust) is drawn into the spinning propeller blades. With the propeller pushing mostly air instead of water, the load on the engine is greatly reduced, causing the engine to race and the prop to spin fast enough to result in cavitation, at which point little thrust is generated at all. The condition continues until the prop slows enough for the air bubbles to rise to the surface. The primary causes of ventilation are: motor mounted too high, motor trimmed out excessively, damage to the antiventilation plate, damage to propeller, foreign object lodged in the diffuser ring. Cavitation as it relates to outboard motors is often the result of a foreign object such as marine vegetation caught on the lower unit interrupting the flow of water into the propeller blades. See, e.g., but not limited to, Carlton, John S., Marine Propellers and Propulsion, Elsevier, Ltd., 1994, ISBN 978-07506-8150-6, which is entirely incorporated herein by reference.

Motorcycles and related two wheel vehicles suitable for use with a hybrid active clutchless transmission can include any type of two wheeled vehicle with at least two power sources. A motorcycle (also called a motorbike, bike, or cycle) is a single-track, engine-powered, two-wheeled motor vehicle. Motorcycles vary considerably depending on the task for which they are designed, such as long distance travel, navigating congested urban traffic, cruising, sport and racing, or off-road conditions.

Construction. Motorcycle construction is the engineering, manufacturing, and assembly of components and systems for a motorcycle which results in the performance, cost, and aesthetics desired by the designer. With some exceptions, construction of modern mass-produced motorcycles has standardized on a steel or aluminum frame, telescopic forks holding the front wheel, and disc brakes. Some other body parts, designed for either aesthetic or performance reasons can be added. A gas powered engine, typically consisting of between one and four cylinders (and less commonly, up to eight cylinders), is coupled to a manual five- or six-speed sequential transmission drives the swing arm-mounted rear wheel by a chain, drive shaft or belt.

Dynamics. Different types of motorcycles have different dynamics and these play a role in how a motorcycle performs in given conditions. For example, one with a longer wheelbase provides the feeling of more stability by responding less to disturbances. Motorcycle tyres have a large influence over handling. Motorcycles must be leaned in order to make turns. This lean is induced by the method known as countersteering, in which the rider steers the handlebars in the direction opposite of the desired turn. See, e.g., but not limited to, Foale, Tony (2006). Motorcycle Handling and Chassis Design. Tony Foale Designs. pp. 4-1. ISBN 978-84-933286-3-4; Motorcycle Design and Technology. Minneapolis: MotorBooks/MBI Publishing Company. pp. 34-35. ISBN 9780760319901; Cossalter, Vittore (2006). Motorcycle Dynamics. Lulu. ISBN 978-1-4303-0861-4; Gaetano, Cocco (2004), each entirely incorporated herein by reference. There are many systems for classifying types of motorcycles, describing how the motorcycles are put to use, or the designer's intent, or some combination of the two. Six main categories are widely recognized: cruiser, sport, touring, standard, dual-purpose, and dirt bike. Sometimes sport touring motorcycles are recognized as a seventh category, and strong lines are sometimes drawn between motorcycles and their smaller cousins, mopeds, scooters and underbones.

Scooters, underbones, and mopeds. Scooter engine sizes range smaller than motorcycles, 50-650 cc (3.1-40 cu in), and have all-enclosing bodywork that makes them cleaner and quieter than motorcycles, as well as having more built-in storage space. Automatic clutches and continuously variable transmissions (CVT) make them easier to learn and to ride. Scooters usually have smaller wheels than motorcycles. Scooters usually have the engine as part of the swing arm, so that their engines travel up and down with the suspension. Underbones are small-displacement motorcycle with a step-through frame, descendants of the original Honda Super Cub. They are differentiated from scooters by their larger wheels and their use of foot pegs instead of a floorboard. They often feature a gear shifter with an automatic clutch. The moped used to be a hybrid of the bicycle and the motorcycle, equipped with a small engine (usually a small two-stroke engine up to 50 cc, or an electric motor) and a bicycle drivetrain, and motive power can be supplied by the engine, the rider, or both. Other non-limiting types of small motorcycles include the monkey bike, welbike, and minibike.

See, e.g., but not limited to, Maher, Kevin; Greisler, Ben (1998), Chilton's Motorcycle Handbook, Haynes North America, pp. 2.2-2.18, ISBN 0801990998; Bennett, Jim (1995), The Complete Motorcycle Book: A Consumer's Guide, Facts on File, pp. 15-16, 19-25, ISBN 0816028990; Stermer, Bill (2006), Streetbikes: Everything You Need to Know, Saint Paul, Minn.: Motorbooks Workshop/MBI, pp. 8-17, ISBN 0760323623, each of which is entirely incorporated herein by reference.

An amphibious vehicle (or simply amphibian), is a vehicle or craft, that is a means of transport, viable on land as well as on water—just like an amphibian. This definition applies equally to any land and water transport, small or large, powered or unpowered, ranging from amphibious bicycles, ATVs, cars, buses, trucks, RVs, and military vehicles, all the way to the very largest hovercraft. Classic landing craft are generally not considered amphibious vehicles, although they are part of amphibious assault. Nor are Ground effect vehicles, such as Ekranoplans. The former do not offer any real land transportation at all—the latter (aside from completely disconnecting from the surface, like a fixed-wing aircraft) will probably crash on all but the flattest of landmasses.

For propulsion in or on the water some vehicles simply make do by spinning their wheels or tracks, while others can power their way forward more effectively using (additional) screw propeller(s) or water jet(s). Most amphibians will work only as a displacement hull when in the water—only a small number of designs have the capability to raise out of the water when speed is gained, to achieve high velocity hydroplaning, skimming over the water surface like speedboats.

ATV's. Amongst the smallest non air-cushioned amphibious vehicles are amphibious bicycles, and ATVs. Although the former are still an absolute rarity, the latter saw significant popularity in North America during the nineteen sixties and early seventies. Typically an Amphibious ATV or AATV is a small, lightweight, off-highway vehicle, constructed from an integral hard plastic or fibreglass bodytub, fitted with six (sometimes eight) driven wheels, with low pressure, balloon tires. With no suspension (other than what the tires offer) and no steering wheels, directional control is accomplished through skid-steering—just as on a tracked vehicle—either by braking the wheels on the side where you want to turn, or by applying more throttle to the wheels on the opposite side. Most contemporary designs use garden tractor type engines, that will provide roughly 25 mph top speed on land.

Constructed this way, an AATV will float with ample freeboard and is capable of traversing swamps, ponds and streams as well as dry land. On land these units have high grip and great off-road ability, that can be further enhanced with an optional set of tracks that can be mounted directly onto the wheels. Although the spinning action of the tires is enough to propel the vehicle through the water—albeit slowly—outboard motors can be added for extended water use. Current AATV manufacturers are Argo, Land Tamer, MAX ATVs and Triton.

Recently some efforts have been made toward amphibious ATVs of the straddled variety. Others include the add-on inflatable pontoon kit, that can be installed on any quad-bike ATV with front and rear metal frame racks and at least 14″ water fording ability.

Skied vehicles. Any suitable vehicle with skies can also be used with a hybrid active clutchless transmission. The most common type of skied vehicle is a snowmobile, also known as a snowmachine, sled, or skimobile, is a land vehicle for travel on various surfaces that are compatable with the use of skies, such as snow, ice or water, and also are used with other surfaces, such as grass, dirt, and asphalt, sometimes with modifications for the alternative surfaces. Designed to be operated on snow and ice, they require no road or trail. Design variations enable some machines to operate in deep snow or forests; most are used on open terrain, including lakes or driven on paths or trails. Usually built to accommodate a driver and optional additional passengers, their use is much like motorcycles and All-terrain vehicles (ATVs), usually intended for winter use on snow-covered ground and frozen ponds and waterways. They have no enclosure other than a windshield and the engine normally drives a continuous track or tracks at the rear; skis usually at the front provide directional control.

Early snowmobiles used rubber tracks, but modern snowmobiles typically have tracks made of a Kevlar composite. Snowmobiles can optionally be powered by two-stroke or four-stroke gasoline/petrol internal combustion engines, with a combination of an electic motor. The contemporary types of recreational riding forms are known as Snowcross/racing, trail riding, freestyle, mountain climbing, boondocking, carving, ditchbanging and grass drags. Summertime activities for snowmobile enthusiasts include drag racing on grass, asphalt strips, or even across water.

A hybrid active clutchless transmission vehicle can include where the propulsion drive shaft drives the propulsion of the vehicle. A drive shaft can drive the propulsion of the vehicle based on any suitable method, which can include direct or indirect linkage to the propulsion mechanism used. An indirect linkage can include any suitable linkage that transfers at least a part of the mechanical energy from the drive shaft to the propulsion system. Non-limiting examples of indirect linkage include, but are not limited to, at least one, or one or more of a transmission, a differential, a gearbox, a gear, a torque converter, a transfer gear or case, or any known suitable type of linkage. Any suitable linkage can include the use of a, at least one, or one or more of, a drive shaft, a chain, a belt, a cam, a transfer plate, a rotor, and the like.

In optional embodiments, a hybrid propulsion system can exclude one or more of the following: a hydraulic motor, a hydraulic clutch, a clutch, a hydraulic drive motor, a high pressure accumulator, a low pressure accumulator, a hydrolic pump for a hydraulic drive motor system, a variable orbital path transmission component, an orbital path transmission component, a variable ratio transmission component, radially sliding or stepping drive or driven gears, orbital path sun gears, orbital path ring gears, orbital path planetary gears, variable orbital path sun gears, variable orbital path ring gears, variable orbital path planetary gears, orbital cycle gears, partial orbital cycle drive or driven gears, orbital cycle, partial orbital cycle, offset ring gears, offset sun gears, offset planetary gears, radially expandable gears, radially expandable drive gears, a two-stage planetary gear transmission, first and second stage planetary gear transmissions, planetary gears meshed with more than one sun gear, an alternator, an accessory motor transmission, accessory motor gearbox, accessory motor, more than one planetary gear system, multiple planetary gear systems, a differential comprising a planetary gear system, vehicle accessory drive, accessory drive output, accessory drive output, accessory drive input, accessory drive planetary gear set, steer motor, steering motor, first clutch, second clutch, a tracked vehicle, tracked vehicle transmission, tracked vehicle transmission, tracked vehicle clutch containing transmission or gearbox, same type of power input, same type of power sources, two electrical motors as power sources in series or parallel arrangement, the planetary gear system is provided between the power sources and perpendicular to the drive shaft; the transfer of torque between the planetary gear system and the propulsion system is via a belt or chain attached to the drive shaft; the planetary gear system is provided physically between the two power sources; four wheel vehicles, and the like.

### EXAMPLES

### Example 1

### Design, Building, And Testing of a Hybrid Propulsion System (HPS) That Can Be Integrated Into The Fuselage Of An Aerial Vehicle

Introduction and Background The objective of this project is to design, build, and test a hybrid propulsion system (HPS) that can be integrated into the fuselage of an unmanned aerial vehicle, as well as other types of vehicles. The goal of the HPS is to effectively decrease fuel consumption on an internal combustion engine (ICE) by decreasing the required ICE power necessary for flight. A hybrid propulsion system will be designed, manufactured and tested for integration into a remotely controlled Unmanned Aerial Vehicle (UAV).

Project Configuration

The HPS will be comprised of four major components: an internal combustion engine, an electric motor, batteries, and photovoltaic (PV) cells. Batteries will be supplemented by the PV cells to provide power to the electric motor. The electric motor will run concurrently with the internal combustion engine through a gearbox to spin a propeller and drive the aircraft. Volumetric dimensions set forth by the airframe, along with weight sizing models, will constrain the design of the HPS. Program scheduling, integration, and quality management are used to ensure that the integration of the two projects proceeds smoothly.

List of Acronyms

| Acronym | Definition |
|---|---|
| AMA | Academy of Model Aeronautics |
| CAD | Computer Aided Design |
| CCS | Current Control System |
| CDD | Conceptual Design Document |
| CDR | Critical Design Review |
| CFO | Chief Financial Officer |
| C.G. | Center of Gravity |
| COMM | Communications Liaison |
| COTS | Commercial-Off-The-Shelf |
| DDD | Davis Diesel Development |
| DWC | Daniel Webster College |
| EAS | Electrically Additive System |
| EM | Electric Motor |
| EMAS | Electrically and Mechanically Additive System |
| ESC | Electric Speed Controller |
| FAA | Federal Aviation Administration |
| FAB | Fabrication Engineer |
| GB | Gearbox |
| HPMAS | Hybrid Propulsion Mechanically Additive System |
| HPS | Hybrid Propulsion System |
| ICD | Interface Control Document |
| ICE | Internal Combustion Engine |
| MAS | Mechanically Additive System |
| MAN | Manufacturing Engineer |
| MIT | Massachusetts Institute of Technology |
| OEI | One Engine Inoperative |
| PDD | Project Definition Document |
| PDR | Preliminary Design Review |
| PM | Project Manager |
| PV | Photovoltaic |
| RPM | Revolutions Per Minute |
| SaE | Safety Engineer |
| SE | Systems Engineer |
| UCB | University of Colorado at Boulder |
| RECUV | Research and Engineering Center for Unmanned Vehicles |

Aerodynamic Restrictions. Designing a propulsion system for an aircraft requires at least a basic understanding of the integration between the two systems. This is especially true due to the weight limitations innate with flying vehicles. To allow proper design in hopes of smooth integration between the UCB HPS and the airframe, several requirements were passed between teams. Included in these requirements are some aerodynamic restrictions UCB placed in the airframe due to propulsion limitations. Some of these include: (1) An airframe weight ≦6 lbs; (2) A static wing area ≧1300 in² for proper PV integration; (3) Cruise velocity of 25 mph; and/or (4) L/D ratio ≧10.

The weight restriction was derived from the optimization program and COTS data where average payload values were modeled. Wing loading, financial restrictions, and power requirements dictated that a minimum of 1300 in² were needed for the PC cells. A low cruise velocity helps decrease the power required of the HPS, allowing for greater endurance. Yet, the most crucial performance requirement that UCB set forth for was the L/D ratio of 10 at cruise. This is an ambitious, yet achievable, mark that allows for the HPS to meet the 30 W/lb power loading restriction instituted by the design area.

The L/D ratio of 10 was iteratively derived. Using the projected weight budget from the optimization code, the required thrust was calculated after selective an L/D ratio:

$${T}_{r} = \frac{W}{L / D}$$

Using the cruise velocity of 25 mph, the power required was derived next:

Pᵣ=TᵣV_{∞}

Next, stall was verified due to the low cruise velocity:

$${V}_{Stall} = \sqrt{\frac{2 W}{ρ {SC}_{Lmax}}}$$

After stall was met, the power required was back solved through estimated propeller efficiencies in order to derive the power available at the propeller shaft.

$${P}_{a} = \frac{{P}_{r}}{η}$$

This value was then distributed over the projected weight of the entire aircraft to find the power loading:

$$\frac{W}{lb} = \frac{{P}_{a}}{W}$$

This process was repeated until the power loading restricting of 30 W/lb was met. This provided an L/D ratio of at least 10 be possible in the airframe during cruise. The final power loading value governing the performance of the HPMAS was found to be 27.5 W/lb.

Computational Model. A computational model was provided according to known methods to determine the sizing power requirements of each component after a complete understanding of the how the HPMAS design met the overall objective and subsequent project requirements were achieved. Starting from the design point selected in the optimization program, the computational model was able to back calculate the power required of the ICE, EM, batteries, and PV cells.

The aircraft is projected to require 27.5 W/lb as specified in the previous section. This value, combined with the weight budget, calculated the total power that the HPMAS needs to deliver to the propeller shaft in order to maintain steady level flight. The ICE needs to produce 152 Watts of mechanical power during cruise. This is the power of the ICE after 25% has been removed to meet the reduced carbon emissions objective. The 525 Watts the EM requires is electrical energy supplied from the battery and PV cell arrays. With respect to the EM and the 30 minutes endurance requirement, the batteries must supply 336 Whr of electrical energy to the EM along with the PV cells producing 29.7 Watts of power to provide positive power to the HPMAS.

Updating the Computational Model. Through design iterations and requirement updates from both the customer and inadequate PV cell performance, the HPS computational model has been periodically updated to reflect the new designs. This allows for the hopes of the computational model accurately converging with real life results. An example of this is the aforementioned PV cell power alterations. In this instance, the PV cells were less powerful than the company specified, resulting in a shift in the power delivered to the EM from the batteries. Other elements have since been added to the model such as thermal analysis from the EM and battery subsystems. The desire is to have the computation model accurately predict the outcome of the entirety of the HPMAS. In the instance where the model will diverge from testing, a full program will help explain why there were inaccuracies.

The three main alternative system designs considered: Electrically Additive (EAS), Mechanically Additive (MAS), and Electrically and Mechanically Additive (EMAS) systems as denoted by the red boxes.and placed them in the purple boxes. Each design alternative was analyzed and compared to maximize HPS efficiency and optimize the system.

Electrically Additive System (EAS). The original design of the EAS derived from the idea of having a single EM output to the propeller shaft due to the ease of direct gearing and heightened efficiency of the EM motor. The ICE would idle at its most efficient operation point. The mechanical power from this ICE would run an alternator, generating electrical current that would then be processed by a voltage regulation circuit. The electrical energy from this process would then be added to the electrical energy of the battery and PV arrays in order to provide the necessary power to the EM for flight. Calculating through, the efficiency for the energy transfer through this subsystem design resolved to 68%. This is mainly due to the losses in converting chemical energy into mechanical energy then to reverting back to electrical energy.

Mechanically Additive System (MAS). The MAS subsystem design was developed from analyzing the PRIUS in order to understand how it mates the ICE and EM components. Through this design, it was found that a specially designed gearing assembly, known as a planetary (or cyclic) gearing system, could allow for collaborative and additive ICE and EM operations. This option was weighed against a mechanical clutch system, but that was eliminated due to the requirement of collaborative component operations. The essence of the MAS subsystem is the planetary gearing system. Both the ICE and EM mechanically run the GB which allows for a single propeller output shaft to be additively driven. The EM is then powered by a battery array and photovoltaic cells. The overall efficiency of this subsystem configuration was found to be 85%.

Electrically and Mechanically Additive System (EMAS). The EMAS design was derived by combining both the EAS and MAS subsystems to take the best parts of each. In the EMAS configuration, the ICE has two energy routes. The first would simulate the EAS, where the shaft power of the ICE would run an alternator to produce electrical energy that would be filtered by a voltage regulator. This electrical energy would then be utilized to power the battery array in tandem with a PC cell array. The batteries would then power the EM which would convert this energy back into mechanical power and run the propeller through a clutch or cyclic gearing system. The alternative ICE energy route inputs directly into the clutch or gearing system to the propeller. The clutch was since eliminated by adding the collaborative operations requirement. The efficiency range was broad, being greater than that of the standalone EAS and near that of the MAS.

PV Cell Selection/Design: For many years PV cells only consisted of a silicon wafers that were inflexible and brittle. In recent years thin-film photo voltaic have made huge strides in efficiency increase. For this reason the team analyzed thin-film, the more traditional wafer and space grade PV cells. It was found that the traditional wafer did not produce the same W/lb as the thin-film as seen in Table 1

TABLE 1
PV Type Selection

| Subsystem | | | | | | | |
|---|---|---|---|---|---|---|---|
| Selection | | Thin-Film | | Space Grade | | Traditional | |
| Parameter | Weight | | SW | S | SW | S | W |
| W/lb | 35% | 3 | 1.05 | 5 | 1.75 | 1 | 0.35 |
| Price | 20% | 3 | 0.6 | 1 | 0.2 | 5 | 1 |
| Integration | 20% | 5 | 1 | 3 | 0.6 | 3 | 0.6 |
| Thickness | 15% | 5 | 0.75 | 5 | 0.75 | 2 | 0.3 |
| Weight | 10% | 4 | 0.4 | 5 | 0.5 | 3 | 0.3 |
| Totals | 100% | | 3.8 | | 3.8 | | 2.55 |

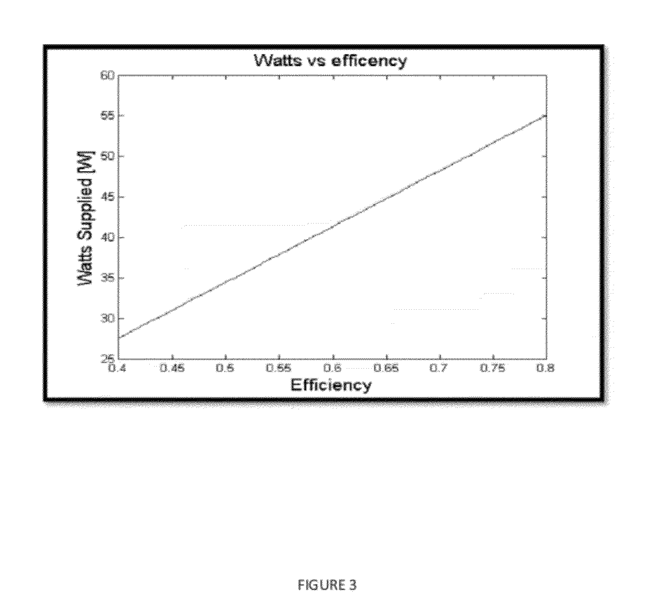

Table 1 was constructed by doing a through market analysis of available products and research into each type of PV cell. The results lead the team to focus on the thin-film and space grade solar cells. Analysis was also done to see how improvement in overall system efficiency would help the overall watts supplied to the system. A graphical representation of these results is in FIG. 3. Currently the efficiency loss by the time the power reaches the propeller is roughly 55% with the slope of this line being almost 0.7. This shows that every little increase in efficiency will really help the amount of power provided to the propeller.

Battery Weight Sensitivities. In order for this project to be successful it was imperative to do battery sensitivity analysis to determine what initial requirements where achievable and which battery characteristics should get the most weight when comparing different battery types. The first sensitivity analysis compared battery weight to flight time (see Figure INSERT below).

Gearbox Type Selection. Three different design options were considered for combining the power from both the ICE and electric motor to a single propeller shaft. The first option considered was a clutching system in which though the use of a switch, the propeller could be powered by either the ICE or electric motor by moving a clutch. While the design of a clutch system may be relatively simple, it does not allow for simultaneous input from the ICE and EM at the same time. The other two options involve a planetary gearing system. A planetary gearbox has three stages of gears, any of which can either be an input or an output. One planetary gear option is the multi ratio planetary gear in which the planet gears have multiple ratios allowing for either an additional gear ratio within the box or an addition input/output.

The other planetary gearing system is the standard planetary gear in which the planets consist of only one gear size. Based on various aspects of each of these three systems, the following trade study seen in Table 2 was conducted.

TABLE 2
Gearbox Type Trade Study

| | | Multi Ratio | | | Standard | | | | | |
|---|---|---|---|---|---|---|---|---|---|---|
| | | Planetary Gear | | | Planetary Gear | | | Clutch System | | |
| Selection Parameter | Weight | Spec | S | SW | Spec | S | SW | Spec | S | SW |
| Manufacturing | 40% | Very Difficult | 0 | 0 | Difficult | 3 | 1.2 | Simple | 5 | 2 |
| Efficiency | 20% | 80 | 3 | 0.6 | 85 | 4 | 0.8 | 99 | 5 | 1 |
| Gear Ratio | 15% | 2x Multiple | 5 | 0.75 | Multiple | 4 | 0.6 | Unitary | 0 | 0 |
| Simultaneous Input | 15% | Yes | 5 | 0.75 | Yes | 5 | 0.8 | No | 0 | 0 |
| Weight [lb] | 5% | 2.5 | 1 | 0.05 | 1.8 | 2 | 0.1 | 0.5 | 5 | 0.25 |
| Cost [$] | 5% | 400 | 1 | 0.05 | 300 | 2 | 0.1 | 100 | 3 | 0.15 |
| Totals | 100% | | | 2.2 | | | 3.6 | | | 3.4 |

The considerations with the highest weights in the trade study were manufacturability, gear transmission efficiency, gear ratio options, as well as the ability for simultaneous input from two sources. Results of this trade study showed that the standard planetary gearbox would be the best selection for the HPS application. Additionally, the planetary gear system was selected over the clutch system, although close in trade study weight, due to the ability of simultaneous input from the EM and ICE.

Controls: Servo Type Selection. For RC aircraft there are two types of servos available. There are standard servos that are widely used among the RC community. These servos are simple and easily integrated into almost any system. The other option is high torque servos. High torque servos operate in the same manner as standard servos with the exception that they provide much higher torques. These servos tend to be much heavier and much more expensive. They are mainly used in sailplane application in which control surface deflection requires more torque than standard RC aircraft. Table 3 lists the trade study completed on servo type.

TABLE 3
Servo Type Trade Study

| Subsystem | | High Torque | | | | | |
|---|---|---|---|---|---|---|---|
| Selection | | Servo | | | Standard Servo | | |
| Parameter | Weight | Spec | S | SW | Spec | S | SW |
| Torque | 10% | 350+ | 5 | 0.5 | 20-50 in-oz | 2 | 0.2 |
| | | in-oz | | | | | |
| Weight [oz] | 20% | 2.4 oz | 1 | 0.2 | 0.5 oz | 5 | 1 |
| Availability | 20% | COTS | 5 | 1 | COTS | 5 | 1 |
| Compatability | 30% | More | 3 | 0.9 | Yes | 5 | 1.5 |
| | | Power | | | | | |
| Cost | 20% | ~$100 | 0 | 0 | ~$15 | 5 | 1 |
| Totals | 100% | | | 2.6 | | | 4.7 |

Based on this trade study it was determined that standard RC servos would suffice and high torque servos are overkill for this application.

Gearbox.

The major risk concerning the gearbox is the manufacturing. High risk concerns the precision of the gears within the system. Since team Helios had little manufacturing experience, this risk rose to the top. A few things have been done to decrease the possibility of this risk. A design prototype was constructed for initial considerations of preliminary overall design. Additionally, a gear prototype was designed for physical manufacturing considerations.

Further manufacturing experience has been acquired by manufacturing parts for the dynamometer and motor mounts for testing the ICE. Although these parts are fairly simple, they have furthered the team's knowledge of the industrial CNC systems. By producing more parts the team has become more confident and familiar with general manufacturing.

Further considerations in the manufacturing of the gearbox have arisen from these steps, however. There is now the added the concern of tolerancing the system. A second gear prototype will be designed and tested to mitigate this concern. Tolerancing issues arise from the difference between designed systems and physical systems and by nature these must be accounted for, primarily with prior knowledge, from trial and error, or learned form a practiced professional. Constant communication with Matt Rhode and the instrument lab staff were used during manufacturing. See Gear Prototype Below for specific details.

The most difficult part to manufacture is the planet carrier. Similar in nature to manufacturing, high RPM of gearboxes require additional attention. From the calculations, the gearbox must be capable of spinning up to 16K RPM. This is much higher than general operations, which run at 5K RPM. Three things arise concerning this risk: components of the gearbox, (materials and primarily the bearings) must be able to handle these high speeds, the system must be aligned properly for little vibration, and the safety of the system must be insured in case of failure.

These risks have decreased with study. First, a hobby store and talked with the workers there, from it was found that gearboxes in RC cars can reach speeds of 90K RPM and are designed with plastic parts. This decreased the concern with components achieving only 16K RPM. Additionally, the ratings of various commercial parts were analyzed and Matt Rhode spoken to concerning this. Furthermore, modeling has proved that materials used will be able to handle these loads. Second, from the prototypes constructed the concern of tolerancing has increased and the need for the alignment during manufacturing will be further studied in the spring semester. Third, concerning the safety of the system, a lightweight part has been designed to encase the gearbox. With testing in the spring semester this risk were further mitigated.

This prototype was built with a standard Erector set. The planetary ring gears shown were cut using the laser cutter found in the ITLL basement. The gear ratio that was created was 0.33 (Sun/Ring) this was due to fit the erector set without having to alter the current set and is not a final design specification.

This prototype was built to show that two input shafts could be spun at the same time and output simultaneously to a third shaft. A second, and possibly more important, thing this prototype showed was the simplicity of the design. The fact that it can be built with a standard toy set shows that the system can be constructed. Since this system is simplistic, for the actual design presented later in this document, there are many design considerations that came directly from this model. These include the consideration of wobble, the simplicity of a base structure, the attachment of the offset input, etc. along with the initial consideration of gear specifications, including diametral pitch, as these gears had to be designed and cut twice due to initial considerations.

This prototype was used for testing the gear ratio equation. A handheld laser based RPM counter was used for data collection. Reasonable Error was found to be minimal.

The second prototype design had a different purpose from the previous. This prototype was designed to: achieve speeds of 20K RPM, study the effect of gear materials after long durations of testing, test gear specs including pitch diameter and diametral pitch, lead to preliminary and general power efficiency ranges. Gears and bearings were purchased commercially off the shelf. A small AXI motor was acquired that would spin the gears up to standard RC motor speeds. An electronic speed controller to control the motor and an ample power supply were also obtained for the test.

During assembly, due to improper tolerance additions, the bearings were broken due to the large loads imparted upon them. However, the prototype was still able to be assembled. Further issues were found in the interaction between the gears. This interaction was due to misalignment of the two gears but the reason this occurred is inconclusive. The primary reasons for misalignment can be attributed to: bearing malfunction causing the gears to misplaced during spin, improper tolerance concerning the pitch diameter measurement (offset), backlash from the small diameter and large diametral pitch of the tested gears. New bearings are in the process of being purchased for further analysis. The goals of this prototype have not yet been achieved but this design process has lead to an increased knowledge in the design and manufacturing of the system. For these reasons, the risk considerations of the manufacturing of the gearbox system have been updated. Redesign and achievement of prototype goals will be completed through the break and at the beginning of the spring semester, to further mitigate this risk.

An additional consideration that was made during the prototyping, was the use of lubricant within the system to decrease friction. Furthermore, acquiring the small AXI motor and ESC has also allowed the team to become familiar with smaller versions of the final design components.

Gearbox

Planetary system and governing equations. As mentioned herein, a planetary gearing system was selected. The planetary gearing system allows for two power inputs to run simultaneously outputting to a single powered output. A planetary gearing system (also known as an epicyclic) is composed of three sets of gears; a large internal gear surrounding the others, a single standard spur gear in the center, and typically two to four spur gears spanning the space between the other two. The standard naming technique for the system is planetary in nature. The internal gear is labeled the ring gear, the center gear is labeled the sun gear and the gears spanning the space are labeled planet gears. The planet gears are held together with a structure labeled carrier (also arm).

A first governing equation for the planetary system is the RPM relation.

$$R = \frac{{N}_{sun}}{{N}_{ring}} = \frac{{ω}_{carrier} - {ω}_{ring}}{{ω}_{sun} - {ω}_{carrier}}$$

Where R is the gear ratio, N is the number of teeth, and ω is the angular velocity.

This equation can be rearranged into another useful form:

Nₛᵤₙ·ωₛᵤₙ+N_{ring}·ω_{ring}=(N_{ring}+Nₛᵤₙ)·ω_{carrier}→R·ωₛᵤₙ+ω_{ring}=(1+R)·ωₐᵣₘ

A gear ratio can be further defined. Since the planet and sun gears must fit into the ring gear a simple summation is produced.

Nₛᵤₙ+2Nₚₗₐₙₑₜ=N_{ring}

A second governing equation for the planetary system is the torque equation which is derived from the power equation.

Pₒᵤₜ=(Pᵢₙ₁+Pᵢₙ₂)·η

P=τ·ω

Where is P the power, η is the efficiency of the gearbox, τ is the torque, and ω is the angular velocity. This equation is used to find the power and output (the propeller).

Specifications

Since the planetary system allows for three components, the system must be well defined for maximum efficiency. Each of the components can be attached to any of the mechanical systems (example: ring can be attached to the propeller, EM or ICE). Also since the gear ratio can be set the system is very dynamic. With this, a preliminary power study was conducted with the propeller, EM and ICE. A robust gear ratio of 0.5 was selected where the propeller was attached to the ring gear, the EM was attached to the sun gear, and the ICE was attached to the planet carrier.

With the gear ratio and the connections selected the standardized output-input gear ratio, Nₒᵤₜ/Nᵢₙ, can be defined. See Table 4 for the conversion of the gear ratio value to the standard gearing vernacular.

TABLE 4
(1)
Gear ratio conversion to standard
System Gear Ratio: 0.5
Propeller → Ring, EM → Sun, ICE → Carrier

| | |
|---|---|
| $\frac{{N}_{out}}{{N}_{in}}$ | $\frac{{N}_{Prop}}{{N}_{EM}} 2$ |
| | $\frac{{N}_{Prop}}{{N}_{ICE}} 4$ |

As previously mentioned, a preliminary power study was conducted with the propeller, EM and ICE and found to be most electrically efficient running the EM at a constant speed. Using this graph of the RPM spectrum was created.

For our system the EM is run at a constant speed of approximately 10,323 RPM however will most likely fluctuate between 9,000 and 11,000 RPM. This allows the ICE to run at a low speed of nearly 2,000 RPM during cruise and up to 6,000 RPM at take off. Take off and cruse conditions are the upper and lower bounds of the optimum propeller speed.

OEI Condition Analysis: EM Out. As determined by further calculations, in the event of the loss of the EM the ICE must increase throttle up to around 5,400 RPM to remain in steady level flight (at the lower optimum bound for the propeller).

ICE Out. As determined by further calculations, in the event of the loss of the ICE the EM must increase throttle up to max RPM of 12,000; however, in this event the aircraft will not be able to sustain steady level flight (at the lower optimum bound for the propeller) and will slowly loose altitude. The propeller spinning at 6,000 RPM will keep the aircraft aloft for a reasonable amount of time allowing the plane to safely land.

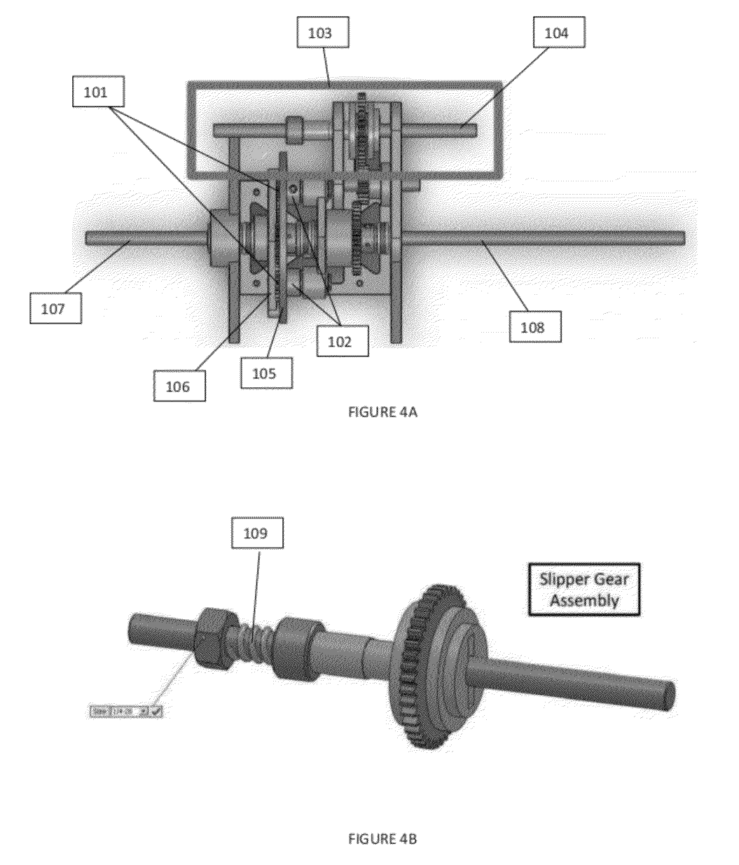

Design. Using these specifications a gearbox was designed. A three dimensional gearbox was created using commercially available software, as final design shown in exploded view in FIG. 4. The gears are purchased commercial off the shelf. The ring, sun and offset gears were selected to be 303 stainless steel because of the high strength properties. The planet gears were selected to be acetal plastic with a stainless steel hub. The ball bearings were purchased commercial off the shelf capable of 20,000 RPM. The base is composed of four parts and was manufactured in the CU Aerospace Instrument Lab. The planet carrier structure and ring gear attachment structure were manufactured in the CU Aerospace Instrument Lab. All parts manufactured in house were composed of Aluminum 6061-T4. Below is a figure of the weight breakdown of the system. The total weight was 0.89 pounds. Lubrication within the system used graphite, MoS2 (molybdenum disulfide based high temperature lubricants, or standard RC lubricants unless oil is required from thermal data and thus the system was submerged in 10 W-30 synthetic motor oil or RC standard oil.

System efficiency verification takes place using the dynamometer. The EM and ICE will both be tested prior to the connection to the gearbox. The efficiency will then be derived from the known inputs. Further information regarding the testing of the Gearbox, EM, or ICE can be found in the Testing and Verification section, as well as additional information concerning the dynamometer.

Further Iterations. Currently the design presented is to be moved forward in manufacturing in the early weeks of the spring semester however further iterations of design were run in order to optimize the design and ideally a second gearbox was manufactured. Since this system is highly dependent on the input power curves an optimized gear ratio and configuration may be may be different from the one presented here. Once testing of Propeller, EM and ICE subsystems these design specifications was established. The specific design is also subject to change in respect to the parts designed. They are currently robust and may be altered to decrease weight. In addition to this, the component material selections are subject to change as well. The possibility of using plastic parts arose. Plastic gears are overwhelmingly standard in the RC field and are used in RC cars where parts spin up to 90,000 RPM. Plastic casement and assembly parts are also standard and was a consideration of further iterations in design. Interchangeable parts were designed such that the components can be adjusted with ease.

All pieces were manufactured out of aluminum except for the casement. The ring assembly was manufactured first. This consists of the large outer gear. The gear was purchased but the attachment mechanism for how the ring gear is held in place must be custom fabricated.

The next part to be manufactured was the planet carrier. This part holds the planet gears in place as they are spun within the gearbox. The next parts manufactured were the supports for the axles within the gearbox. The final part to be manufactured was the gearbox casement. It was manufactured out an acrylic to save weight. This required the necessary spindle and feed rates for the material.

Gearbox. The most important and complex subsystem to be integrated is the gearbox. This is due the number of parts and the precession needed for these parts. Another concern was the necessity for the majority of the gearbox to be manufactured before it can be fully assembled.

The integration for this subsystem consisted of three main components. The first assembly was the ring assembly. The second assembly was the ring gear assembly and the final being the support and casement assembly. These are highlighted in FIG. 4A-B. All set screws and screw will have locktite applied to them to ensure that they do not loosen due to the high RPMs expected. They used a low strength locktite initially unless it is proven that a higher strength is needed. This lower strength will allow for parts to be removed with ease.

The ring assembly starts with the manufacturing of the ring gear support arm. Next, a ball bearing is inserted into the ring support arm. Once this is completed, holes are drilled into the cots ring gear. These are threaded and then the two pieces are screwed together. The assembly will follow the manufacturing schedule.

As shown in FIG. 4A-B, this ring assembly consists of: ring gear 1x; ring support 1x; screws 3x; ball bearing 1x. the next part of the gearbox to be integrated and assembled is the planet assembly. the planet assembly is a bit more complicated than the ring assembly as the number of parts used is quite larger. the planet assembly carries the planet gears within the gearbox. first, the carrier arm must be manufactured. from here ball bearings were inserted. Following next was the attachment of the planet gears themselves. The assembly was completed when the gear is attached to the back of the planet carrier.

As shown in FIG. 4A-B, this planet assembly consists of: (101) planet gears 3x; operably connected to: (102) planet carrier 1x; operably connected to: (103) slipper gear assembly; operably connected to (104) ice power drive shaft; and (105) ring gear 1x; operably connected to: (106) ring carrier 1x; operably connected to: (107) propeller drive shaft; operably connected to (108) em power drive shaft. the power source input includes an ice input to the (104) ice power drive shaft (on top of FIG. 4A) which drive shaft is extended to include an additional extension on the ICE power source to include a connection to the starter system and to add the (104) slipper gear assembly (as a (109) passive spring clutch (as shown in FIG. 4B) to accommodate temporary high torque to temporarily disengage the ICE power input.

The final integration assembly for the Gearbox is the support can casement assembly. This must be completed after the ring and plant assemblies as those were enclosed within the casement. First, the supports must be manufactured. After they are manufactured they were assembled together. The casement will then be attached to the supports. Finally, the ring and planet assemblies were integrated by attaching the drive shafts.

FINAL GEARBOX AND INTEGRATION ASSEMBLY: With the successful completion of the ring, planet, and support and casement assemblies, the gearbox was completed, as shown in FIG. 4A-B, with FIG. 4A showing final gearbox (3.1) having an additional extension on the ICE power source to include a connection to the starter system and to add a (109) passive spring clutch (as shown in FIG. 4B) to accommodate temporary high torque to temporarily disengage the ICE power input. During assembly testing and verification was performed in accordance with the testing and verification planes to ensure proper construction and quality control. During the final assembly the gears were lubricated and readied for gearbox testing.

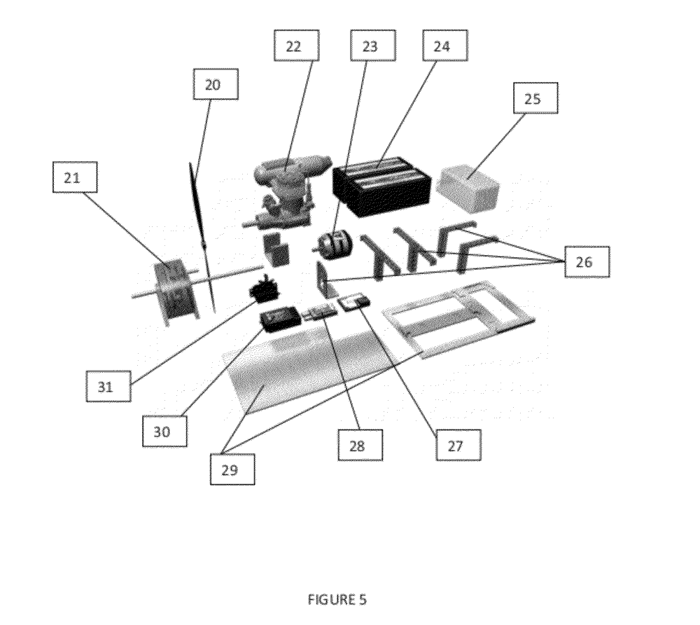

HPS. Once all subsystems were assembled, integrated, and all subsystem tested, the final HPS was integrated together as shown in FIG. 5 in exploded view.

In FIG. 5, the propeller 20 is driven by propulsion drive shaft and planetary gearbox 21 which is driven by ICE 22 and EM 23 powered by batteries 24 and ICE fueled by fuel tank 25. The components listed above are attached to base plates 29 via mounting brackets 26, as well as ESC, servos and current control module 27, 28, 30 and 31. This was the main system integration onto the base plate that was then integrated into the aircraft. This total system integration was a critical part of the project as it was the final step towards having a finalized product. The full integration was completed after Integration of the full HPS system starting with the gearbox 21. For the gearbox, like most other components, the integration consisted of screwing the subsystem to the base plate 29. Screws used to mount the gearbox 21 to the base plate 29 with locktite applied. Next, the ICE 22 and EM 23 were integrated onto the base plate 29. When these two items were integrated they were first attached to their respective mounting plates 26 for integration to the base plate 29. Once again, locktite and screws were used for this process. Once this is complete each motor was slid into a collar attaching it to the gearbox 21. The set screws for these collars were locktited and tightened to secure the motors. Next, screws were locktited and tightened to secure the EM 22 and the ICE 23 to the base plate 29. Secondary items like the receiver, ESC, servos, and current control module (27, 28, 30, 31) were attached using double sided tape and Velcro so that they can be removed with ease. Finally, the batteries and fuel tank were zip tied to the secondary base plate. The fuel lines from the tank 25 were run to the ICE 22. The power lines from the batteries 24 were attached to the proper locations including the current control module 27. The base plate 29 was attached to the aircraft for best fit. Once the base plates 29 were attached, the wings were attached to the fuselage and the wires for the solar cells were hooked up to the current control module. This will complete the full system integration.

In understanding the scope of the present invention, the term “comprising” and its derivatives, as used herein, are intended to be open ended terms that specify the presence of the stated features, elements, components, groups, and/or steps, but do not exclude the presence of other unstated features, elements, components, groups, and/or steps. The foregoing also applies to words having similar meanings such as the terms, “including”, “having” and their derivatives. Also, the terms for structural elements when used in the singular can have the dual meaning of a single part or a plurality of parts. Dimensions shown within this disclosure are exemplary and can be adjusted such that the end result is not changed.

While only selected embodiments have been chosen to illustrate the present invention, it were apparent to those skilled in the art from this disclosure that various changes and modifications can be made herein without departing from the scope of the invention as defined in the appended claims. The present invention could be used in the context of other vessels or vehicles. For example, the propeller could be a ship's propeller or the system could be connected to a drive train for a vehicle. Furthermore, the foregoing descriptions of the embodiments according to the present invention are provided for illustration only, and not for the purpose of limiting the invention as defined by the appended claims and their equivalents.

What is claimed is:

1. A clutchless hybrid transmission system for aeronautical vehicles, comprising
a. one planetary gearing system that provides alternating or simultaneous power coupling between at least two sources of power and at least one propulsion drive shaft.

2. A hybrid propulsion system for aeronautical vehicles, comprising:
a. at least one clutchless hybrid transmission system according to claim 1; and
b. at least two sources of power.

3. A hybrid propulsion system according to claim 2, wherein said at least two sources of power comprise one internal combustion engine (ICE) and one electric motor (EM).

4. An aeronautical vehicle, comprising at least one clutchless hybrid transmission system according to claim 1.

5. A vehicle according to claim 4, wherein said vehicle is selected from an unmanned aeronautical vehicle and a manned aeronautical vehicle.

6. A vehicle according to claim 5, wherein said propulsion drive shaft drives the propulsion of said vehicle.

7. A vehicle according to claim 5, wherein said propulsion drive shaft driving the propulsion of said vehicle is via one or more of at least one transmission, at least one differential or gearbox that operates at least one angle between 0 and 180 degrees.

8. A vehicle according to claim 7, wherein said propulsion is via at least one propulsion device selected from an aeronautical propeller or turbulence generating device, wherein said propulsion device is operable connected to said drive shaft.

9. A clutchless hybrid transmission system according to claim 1, comprising at least one sun gear, at least two planetary gears, and at least one ring gear.

10. A clutchless hybrid transmission system according to claim 9, further comprising at least one carrier or arm operably connected to at least one of said at least one sun gear, at least one of said two planetary gears, and at least one ring gear.

11. A clutchless hybrid transmission system according to claim 10, wherein at least one of said at least one propulsion drive shaft is connected to one of said at least one sun gear, at least one planetary gear, and at least one ring gear.

12. A clutchless hybrid transmission system according to claim 11, wherein said connection is via said at least one carrier or arm.

13. A clutchless hybrid transmission system according to claim 8, wherein said propulsion drive shaft is connected to said ring gear via said carrier or arm and said at least two sources of power are connected via dual power drive shafts that are separate or concentric and each drive a different of said planetary gear and said sun gear that drive the propulsion drive shaft of said propulsion system, wherein said sun gear, planetary gear and said ring gear are substantially in the same plane.

14. A clutchless hybrid transmission system according to claim 10, wherein the ratio of said at least one planetary gear and said at least one sun gear is between about 0.2 and about 0.8.

15. A clutchless hybrid transmission system according to claim 11, wherein the ratio of said at least one planetary gear and said at least one sun gear is about 0.5.

16. A clutchless hybrid transmission system according to claim 1, further comprising a slipper gear assembly operably attached to the propulsion drive shaft.

17. A clutchless hybrid transmission system according to claim 1, further comprising at least one battery or electrical storing system that powers said EM.

18. A clutchless hybrid transmission system according to claim 17, wherein said ICE charges said battery or electrical storing system.

19. A clutchless hybrid transmission system according to claim 1, wherein said ICE and EM power said propulsion drive shaft simultaneously as a mechanically additive system.

20. A method for transferring power from at least two power sources to at least one propulsion drive shaft in an aeronautical vehicle, comprising
a. providing a hybrid propulsion system comprising at least one clutchless hybrid transmission system comprising a planetary or epicyclic gearing system that provides alternating or simultaneous power coupling between said at least two sources of power and said at least one propulsion drive shaft of said hybrid propulsion system.
